(19) United States
(12) Patent Application Publication
(10) Pub. No.: US 2005/0129108 A1
(43) Pub. Date: Jun. 16, 2005

(54) Remote video inspection system

(75) Inventors: Clark Bendall, Syracuse, NY (US); Tom Britton, Syracuse, NY (US); Edward B. Hubben, Skaneateles, NY (US); Thomas W. Karpen, Skaneateles, NY (US); Thomas Eldred Lambdin, Auburn, NY (US); Raymond A. Lia, Auburn, NY (US); Jon Salvati, Skaneateles, NY (US); Joshua Scott, Jordan, NY (US); Ken von Felten, Cazenovia, NY (US); Todd Abernethy, Skaneateles, NY (US); Scott Osiecki, Skaneateles, NY (US)

Correspondence Address: WALL MARJAMA & BILINSKI, 101 SOUTH SALINA STREET, SUITE 400, SYRACUSE, NY, 13202, US

(73) Assignee: EVEREST VIT, INC., Flanders, NJ (US)

(21) Appl. No.: 10/768,761

(22) Filed: Jan. 29, 2004

Related U.S. Application Data
(60) Provisional application No. 60/443,521, filed on Jan. 29, 2003.
(60) Provisional application No. 60/520,996, filed on Nov. 18, 2003.

(51) Int. Cl. H04N 7/12; H04N 7/18

(52) U.S. Cl. 375/240.01; 348/65; 348/85

(57) ABSTRACT

A modular remote video inspection system for inspecting the interior of a living thing or of an inanimate object, such as a machine. The system comprises a base module connected by way of an interconnection module to a handset comprising a unitary display module and control module. The system makes observations by generating light that is caused to impinge on a surface of the interior of the object of interest. An inspection module attached to the handset comprises both a light guide for providing the light to the area of interest, and a selected one of a sensor and a light receiver. The inspection module comprises a steerable tip configured to be located adjacent the area of interest. The handset includes both controls for operating the system, and a display for providing a view of the region being inspected, as well as status information for the user of an operator.

### CROSS-REFERENCE TO RELATED APPLICATIONS

This application claims priority to and the benefit of co-pending U.S. provisional patent application Ser. No. 60/443,521, filed Jan. 29, 2003, and of co-pending U.S. provisional patent application Ser. No. 60/520,996, filed Nov. 18, 2003, each of which applications is hereby incorporated by reference in its entirety.

### FIELD OF THE INVENTION

This invention relates generally to remote video inspection systems, and in particular to a comprehensive remote inspection system that utilizes modular units, including a computation module, and that can communicate with a central computer workstation.

### BACKGROUND OF THE INVENTION

Inspection units for remotely inspecting the interior portions of a body cavity of a living thing such as a person for medical diagnosis or a medical procedure, or for inspection or possibly repair of interior portions of industrial equipment, such as a boiler, a pipe or an engine, are known. Such systems are commonly large and inconvenient to move to a remote site for inspection operations. For on-site inspections, such systems typically are housed in large cases, or may even require a motor vehicle for transportation.

These systems, as described, have deficiencies in aspects such as portability and convenience that are general needs in the industry. There is a need for borescope and endoscope systems that provide improved convenience for the user while offering greater technical capabilities, better maintainability, and more favorable economics.

### SUMMARY OF THE INVENTION

The borescope and endoscope systems that can be manufactured, provided, and operated according to principles of the invention offer improved convenience, for example, rapid set-up time and a very short interval to become operational, interchangeability between flexible probes, or for one-step remote inspection, and improved technical capabilities. Borescope and endoscope systems according to principles of the invention are intended for remotely inspecting the interior portions of a body cavity of a living thing such as a person for medical diagnosis or a medical procedure, or for inspection or possibly repair of interior portions of inanimate objects or equipment, such as a boiler, a pipe or an engine. In some embodiments, the system of the invention is designed to provide an operational system within 15 seconds of being carried to a location at which an object of interest is to be inspected.

In one aspect, the invention relates to a modular remote visual inspection system used to view a portion of an interior of an object of interest. The system comprises a base module, an interconnection module having two ends, a unitary display module and control module, and a demountable inspection module having two ends. The base module comprises an optical source module, a computation module, and a power module. The interconnection module provides electrical and optical signal paths. A first end of the interconnection module is in electrical and optical communication with the base module and the unitary display module and control module in electrical and optical communication with a second end of the interconnection module. A proximal end of the inspection module is in at least optical communication with the unitary display module and control module, and a distal end of the inspection module is configured to make observations of an object of interest. The base module, the interconnection module, the unitary display module and control module, and the demountable inspection module cooperate to permit a view of a portion of an interior of an object of interest.

In one embodiment, the base module, the interconnection module, the unitary display module and control module and the demountable inspection module are configured to be stowed in an interconnected relationship. In one embodiment, the base module, the interconnection module, the unitary display module and control module and the demountable inspection module are configured to be deployed for use without alteration of the interconnected relationship that existed when stowed. In one embodiment, the interconnection module, the unitary display module and control module and the demountable inspection module are configured to be transported in one hand of a user. In one embodiment, the modular remote visual inspection system is configured to be operational within 15 seconds of being carried to a location at which the object of interest is to be inspected.

In one embodiment, the system further comprises a container module for storing the system therein and for transporting the system to an inspection location. In one embodiment, the container module comprises a body and a lid.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 illustrates a first exemplary embodiment of the remote video inspection system of the invention;

FIGS. 1A through 1C are perspective drawings that illustrate an alternative embodiment of the remote video inspection system of the invention;

FIG. 2 illustrates in greater detail the first exemplary embodiment of a base module according to the invention;

FIG. 2A is an end-view sectional drawing of the system according to the principles of the invention;

FIG. 2B is a perspective cutaway view of the system according to the principles of the invention;

FIG. 3 illustrates an exemplary handset and cable useful for practicing the invention;

FIG. 4 illustrates an exemplary interchangeable demountable inspection module insertion tube useful for practicing the invention;

FIG. 5 illustrates features of a second embodiment showing the system in front view, according to principles of the invention;

FIG. 6 illustrates features of the second embodiment showing the system in a side view, according to principles of the invention;

FIG. 7 illustrates features of the second embodiment showing the system in a rear view, according to principles of the invention;

FIG. 8 illustrates features of the second embodiment showing the system with the container module closed, according to principles of the invention;

FIG. 9 illustrates features of the second embodiment showing the system in a perspective view, according to principles of the invention;

FIG. 10 illustrates features of the second embodiment in a close-up view of a portion of the view of FIG. 9, according to principles of the invention;

FIG. 11 illustrates features of the second embodiment showing a close-up view of an extended handle and a support bracket, according to principles of the invention;

FIG. 12 illustrates features of the second embodiment showing the container module after the base module has been removed, according to principles of the invention;

FIG. 13 illustrates features of the second embodiment, showing a system with a keyboard in a pull-out shelf, according to principles of the invention;

FIG. 14 illustrates features of the second embodiment, showing a close-up side view of a handset supported on a support bracket, according to principles of the invention;

FIG. 15 illustrates features of the second embodiment, showing a base module with a handset, cable and insertion tube in deployed configuration, according to principles of the invention;

FIG. 16 illustrates features of the second embodiment, showing a base module with a handset, cable and insertion tube in stowed configuration, according to principles of the invention;

FIG. 17 illustrates features of the second embodiment, showing a base module with a handset, cable and insertion tube in stowed configuration being transported in one hand of a user, according to principles of the invention;

FIG. 18 illustrates features of the second embodiment, showing a base module with a handset, cable and insertion tube in deployed configuration, with a spare insertion tube in an opened storage container, according to principles of the invention;

FIG. 19 illustrates features of the second embodiment, showing a base module with a handset, cable and insertion tube in deployed configuration, according to principles of the invention;

FIG. 19A is a drawing showing an alternative strap embodiment in which there are no hooks on the handset, according to principles of the invention;

FIG. 20 illustrates features of the second embodiment, showing a base module with a handset, cable and insertion tube in deployed configuration, according to principles of the invention;

FIG. 21 illustrates features of the second embodiment, showing a base module with a handset, cable and insertion tube in deployed configuration, according to principles of the invention;

FIG. 22 illustrates features of the second embodiment, showing a cross-sectional drawing of the handset, according to principles of the invention;

FIG. 23 illustrates features of an embodiment, showing in cross-section a strain relief according to principles of the invention;

FIG. 24 illustrates a user performing an aircraft engine inspection in the field with a system in a backpack configuration, according to principles of the invention;

FIG. 25 illustrates an example of a prior art inspection system that is inconvenient to carry;

FIG. 26 is a perspective drawing that illustrates features of a handset according to principles of the invention;

FIG. 27 is a side view drawing that illustrates features of a handset according to principles of the invention;

FIG. 28 is a perspective drawing that illustrates features of an accessory remote control, according to principles of the invention;

FIG. 29 is a high level block diagram of a circuit used for interfacing an insertion tube with a handset, according to principles of the invention;

FIG. 30 is a high level block diagram of a circuit used for interfacing a base module with a handset, according to principles of the invention; and

FIG. 31 illustrates an embodiment of a reel useful for storing an insertion tube, according to principles of the invention.

### DETAILED DESCRIPTION OF THE INVENTION

The borescope or endoscope system of the invention is designed to provide a user with a compact, readily transported, self-contained, robust system that is ready for operation upon reaching a location where an inspection of interest is to be performed. The system of the invention can also be described with reference to apparatus of Everest VIT, Inc. of Flanders, N.J., as a complete integrated VideoProbe inspection system that includes a PC workstation and spare interchangeable probes in a shippable, weatherproof outer package. The remote video inspection system can inspect a body cavity or other suitable remote target area and can generate a finished video image, either streaming or still, of the target area. The system can also create, record, and transmit or send inspection reports without additional hardware. The system includes the capability to communicate with a central data processing facility, directly or by way of a network (such as the Internet), both to transmit information relating to the inspection of interest, as well as to obtain information available from the central processing facility as needed, such as data, computer programs or software modules, and documents in electronic format. The system can send information to an on-line database (i.e., an engine inspection record database). The remote video inspection system 100 can provide measurements, and can be controlled by a user to annotate images and/or data, and to prepare reports. The remote video inspection system is modular, and will be described with regard to the various modules.

Modularity provides a number of significant advantages. A system that requires four or five modular elements can be assembled and operated using any embodiment of the first module element, any embodiment of the second module element, and so forth using one of each of the four or five required elements. Modular systems are economical to upgrade, as only the module wherein the improvement is being implemented needs to be changed. Modular systems are economical to repair and maintain, and require limited, or essentially no downtime, because a faulty module element can be exchanged and fixed “offline” while the system continues to operate. Modularity facilitates the provision of spare parts in the field; components that are often exhausted, or that may be changed frequently to attain some specific goal are readily provided in multiple numbers or in variants. Modularity also makes it easy to configure a system to accomplish any one of a variety of tasks as the need arises.

Container Module

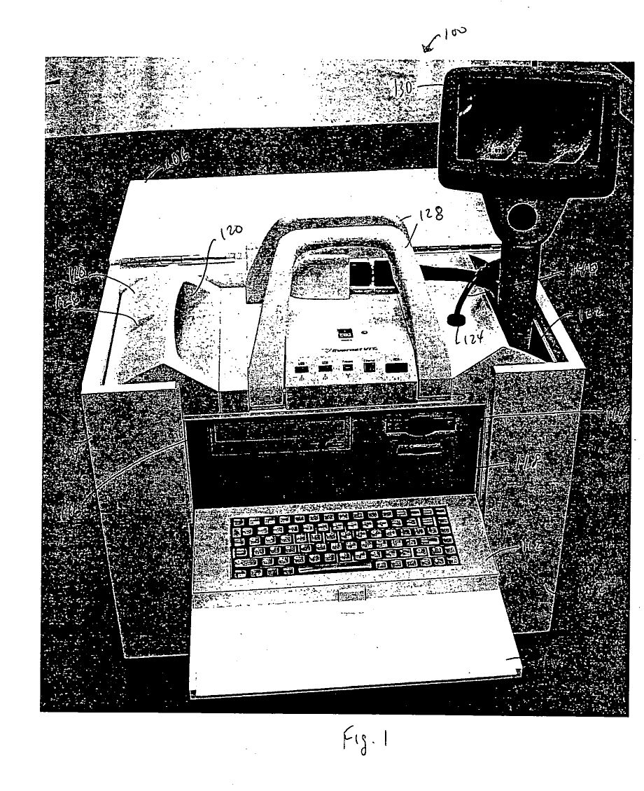

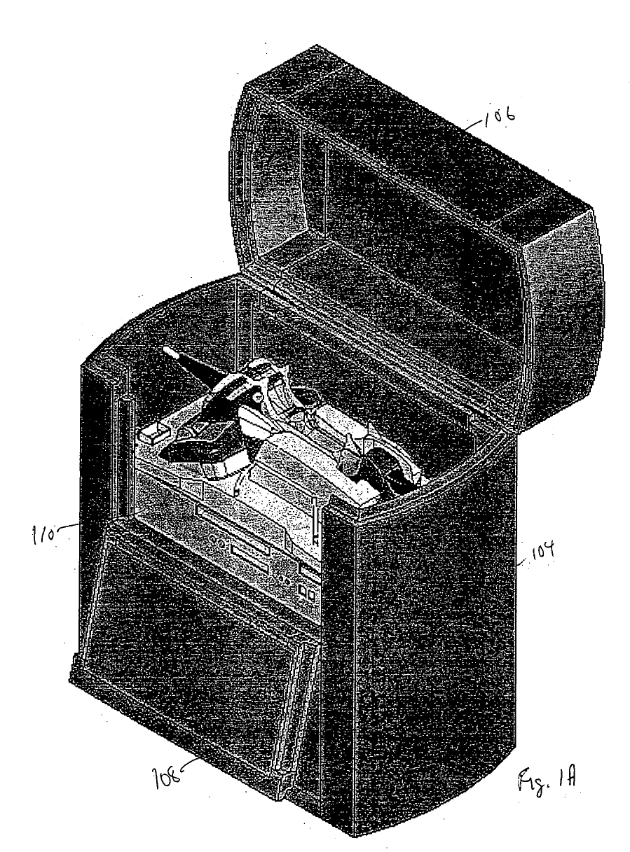

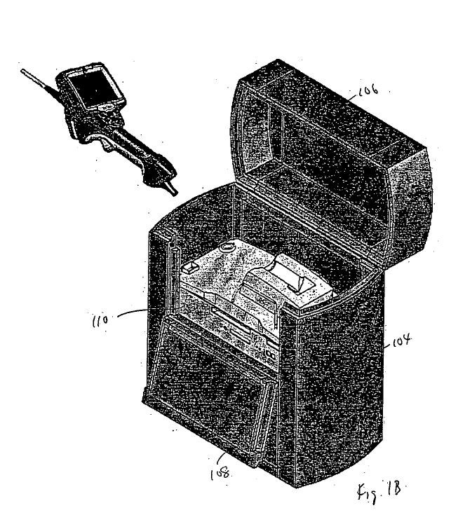

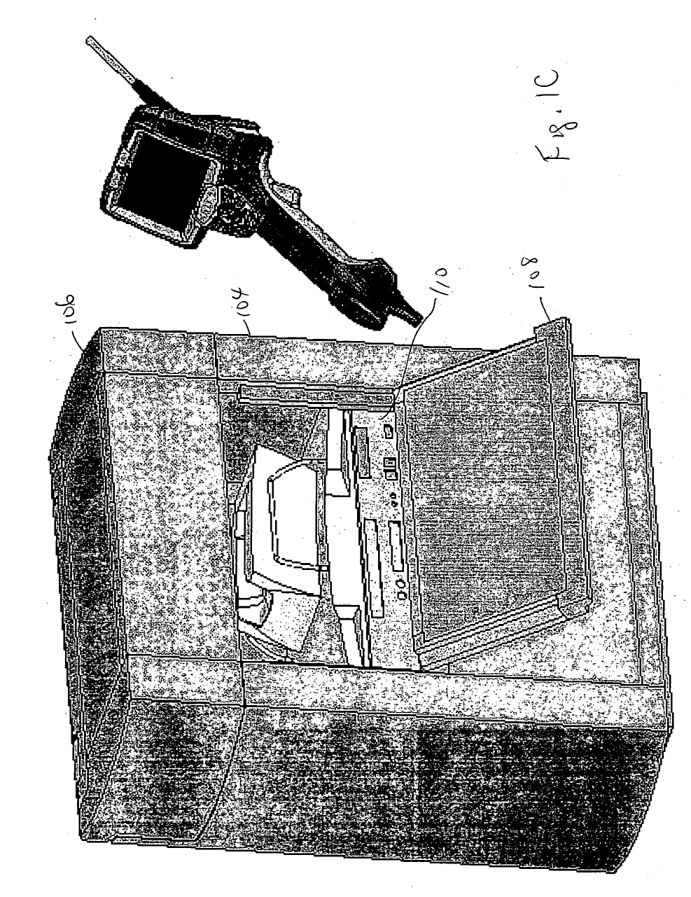

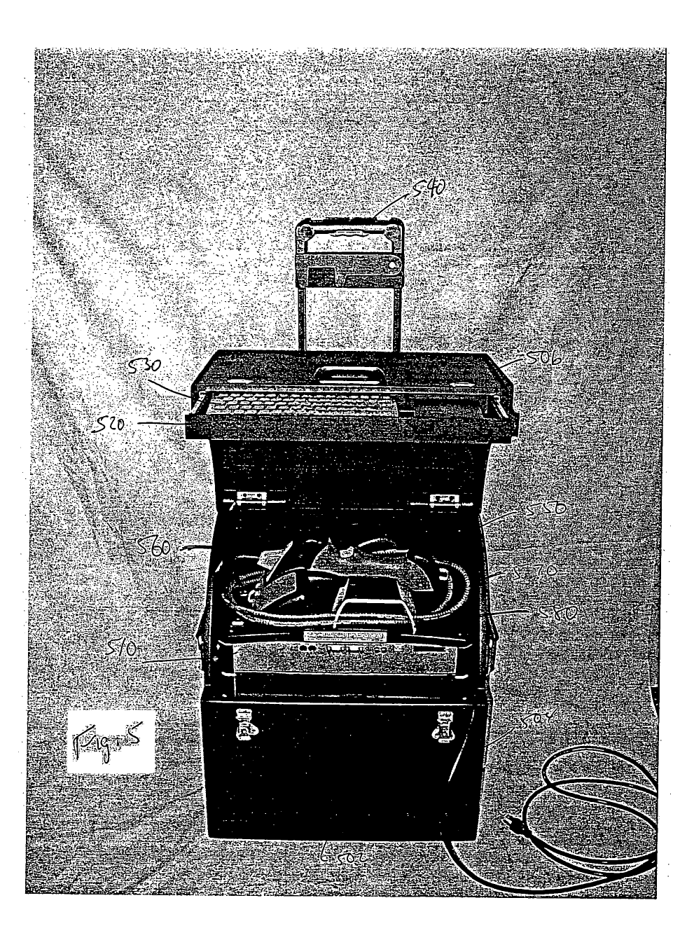

As shown at a high level in FIG. 1, a first embodiment of the remote video inspection system 100 of the invention comprises a container module 102, such as a plastic case comprising a body 104 and a lid 106. Another embodiment of the remote video inspection system 100 of the invention is shown in FIGS. 5-23, which will be discussed further hereinbelow. FIG. 1 depicts the container module in an opened configuration, allowing the viewer to see some of the other components of the remote video inspection system (remote video inspection system 100) and their relation to the container module 102. As will be described in greater detail, the lid 106 in some embodiments is attached to the body 104 with friction hinges that can hold the lid 106 in any position, or a fixed number of set positions, such as a full open position, a workstation position, a rain shield position, and a closed position. In one embodiment, a handle locks the lid 106 in a workstation position. The lid 106 may have detents or one or more mechanical snaps which lock into features on the handle posts. In some embodiments, the lid 106 provides a flat surface workstation when maintained in at least one orientation relative to the body 104.

The container module 102 is a weatherproof outer package that is designed to be of convenient dimension and weight, for ease and convenience of handling, transport, and storage. The container module 102, when closed, also provides protection for the remainder of the remote video inspection system from impacts with other objects, as well as protection from vibration and other hazards of transportation. In addition, the remote video inspection system can be operated using the container module 102 as a holder or working area for the remaining components, to be discussed hereinafter. As shown in FIG. 1, a door 108 provided on a side of the container module 102 can be opened during the operation of the remote video inspection system 100; when open, the door 108 can perform the functions of a work surface. An alternate embodiment shown in FIGS. 1A through 1C, which permits the lid 106 to remain is fully closed and the door 108 is open allowing operation of the unit in a foul weather environment. During such operation the container module 102 is mechanically stable and designed to be stationary. The container module 102 in one embodiment is provided with a telescoping handle, and with wheels, for example wheels having a diameter of approximately 5 inches and a width of approximately 1.5 inches. In some embodiments, the wheels of the container module 102 are spaced widely for rolling stability and to permit rolling, without falling, for example, through industrial grating and to span steel grating. In one embodiment, the extended telescoping handle provides a handle situated approximately 40 inches distance from a surface in contact with the wheels. A long telescoping handle is useful to avoid the container module 102 bumping into a user who pulls the container module 102. The telescoping handle can optionally comprise a mount for hanging a unitary display module/control module, also referred to as a handset, according to the preference of the user. The container module 102 can optionally have one or more handles on an external surface, which handle or handles can optionally be foldable.

The container module 102 in one embodiment is of a rectangular shape, with rounded edges and corners. The container module can optionally comprise any or all of a latch, a provision for locking the container module 102, for example with a padlock or with a lock having a key available to airline security personnel, a position adapted to receive a shipping label, and provision to receive an identification tag. The container module 102 in some embodiments is configured so as to be capable, when the telescoping handle is extended, of rolling on the wheels thereof within the confines of an aisle of a commercial airplane. The container module 102 can optionally be configured so as to be capable, when the telescoping handle is stowed, to fit conveniently into travel compartments, such as an airline storage bin, and to be of such dimensions as to be acceptable as carry on luggage on a commercial airplane. The container module 102 is designed to contain a number of operation modules, to be described in greater detail below, as well as spare parts, tools, auxiliary power sources, supplies, documentation and other items that are useful in operating the remote video inspection system. As depicted in FIG. 1, the container module 102 has space for a base unit or base module 110. The base module 110 is the main operational module of the remote video inspection system 100.

The container module 102 is sized to define a space for the storage of multiple spare flexible probes as a single kit. Preferably, the walls of the container module 102 are double-walled to effectively protect contained equipment with minimum weight. In various embodiments, foam inserts may optionally be used for further protection of the contents of the container module 102. In one embodiment, the lid 106 of the container module 102 protects the contents from rain when open. In some embodiments, the lid 106 locks open and provides a horizontal working surface. In some embodiments, the lid 106 also provides additional features such as a cup holder, a keyboard holding means, such as a tray, as well as means for storing the keyboard. In some embodiments, the lid 106 is limited in its opening angle such that motion of the lid does not cause the center of gravity of the lid 106 to travel beyond a “tip-over” point, so as to prevent the system from becoming mechanically unstable.

The container module in various embodiments can have storage for one or more endoscopes in the enclosed case; a lid that can be an integrated rain shield; a container with integrated handset mounting mechanism in the lid, on an extension pole, on the container handle or in a similar manner.

Base Module

In FIG. 1, the base module 110 is depicted in a partially opened configuration, in which a keyboard 112 rests on the opened door 108 of the container module 102. In some embodiments, the keyboard 112 is a computer keyboard comprising an industrial grade keyboard having raised silicone rubber keys. In one embodiment, the keyboard 112 is ruggedized and sealed to prevent the penetration of liquids thereinto when operated in a field environment, which may be wet. The use of membrane-type keyboards in such environments is also possible. In some embodiments, the keyboard 112 is a foldable keyboard. A computation module is provided within the base module 110, as may be expected to be connected to the computer keyboard, but is not shown explicitly in FIG. 1. In one embodiment, the computation module is in the form of a digital computer contained within the base module 110. In one embodiment, the keyboard 112 is hinged at one extremity to the base module 110. Alternatively, the keyboard 112 can be pulled from the base module 110 and placed on a convenient surface. In some embodiments, the keyboard 112 includes a pointing device, such as a mouse or trackball. When the keyboard 112 is positioned as shown in FIG. 1, one or more openings are uncovered in the side of the base module.

As depicted in FIG. 1, the base module 110 has defined in a side thereof one or more apertures for use with electronic, magnetic and/or optical storage media. In the embodiment depicted in FIG. 1, an opening 114 is the entry opening of a PCMCIA card or PC card slot; an opening 116 is an opening for access to a device bay that can accommodate any of a DVD drive or a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks), hard disks, or a floppy disk drive that uses 3.5 inch magnetic floppy disks; and an aperture 118 that accepts electronic storage media, such as Compact Flash cards, or alternatively SD or SDIO memory. Not shown, but present within the base module 110, are the electronic components (e.g., floppy disk drive, DVD drive, CD/CD-R/CD-RW drive, or Compact Flash/PCMCIA/PC card/SD adapter) that accommodate and read from and/or write to the storage media that can be employed by a user of the remote video inspection system 100. A hard disk or flash drive is optionally provided within the base module 110 for recording data, programs, reports, images, and other information thereon. As is known to those of skill in the electronic storage media arts, new media and formats for data storage are continually being devised, and any convenient, commercially available storage medium and corresponding read/write device that may become available in the future is likely to be appropriate for use in the remote video inspection system 100, especially if it provides any of a greater storage capacity, a higher access speed, a smaller size, and a lower cost per bit of stored information. For example, DVDs using red lasers have a storage capacity of about 4.7 gigabytes (4.7 Gb), while DVDs employing blue lasers have a storage capacity of about 27 Gb. In the future, one may expect that DVDs or similar optically driven storage and retrieval devices that use ultraviolet lasers will be available that have still higher capacities.

The base module 110 provides on-board MPEG-2, MPEG-4, or DV video compression. In other embodiments, other video known video compression methods and formats can be employed. In addition, in some embodiments, audio content can also be recorded using any conventional format, including generating digital audio such as .wav files. The base module 110 also can include various connectivity options, e.g., serial ports, USB ports, Firewire® (IEEE 1394) port, etc., for connecting to other electronic systems, for example, a personal digital assistant. The base module 110 comprises an infrared communication port for receiving commands from an IR device, such as a battery powered remote control unit. In some embodiments, the infrared communication port is compatible with the IrDA® (Infrared Data Association) communication standard. As such, the inventive system is extremely flexible and open in terms of both electronic and software architecture.

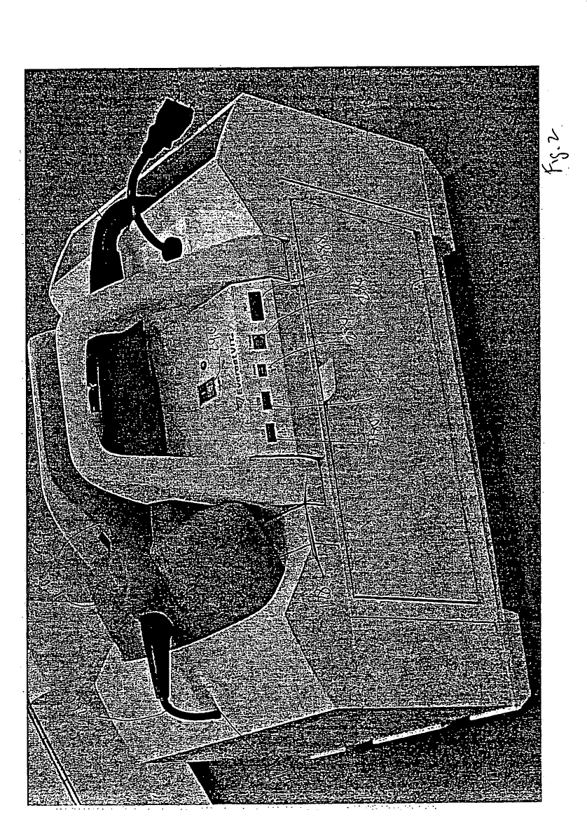

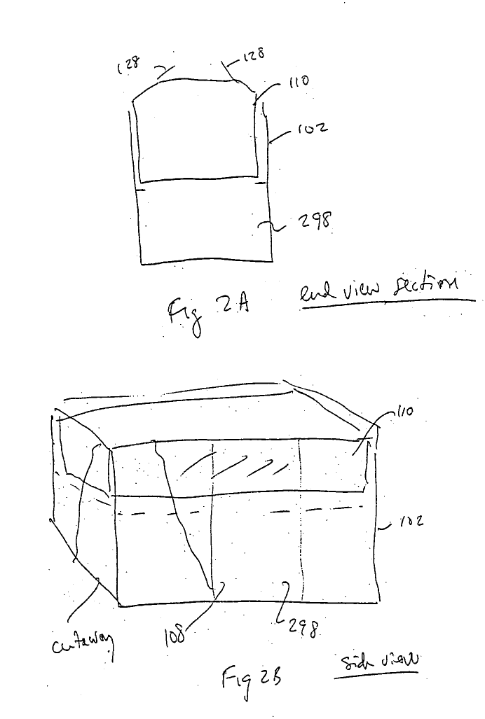

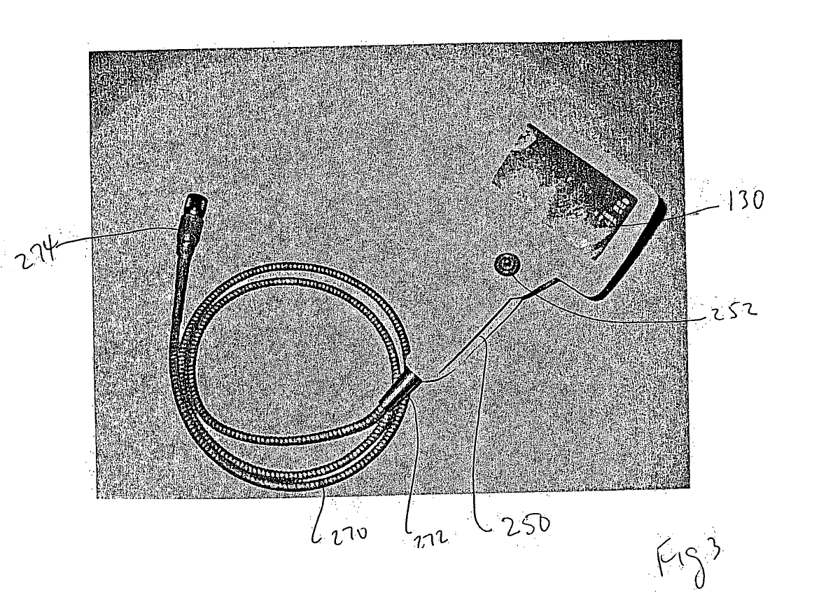

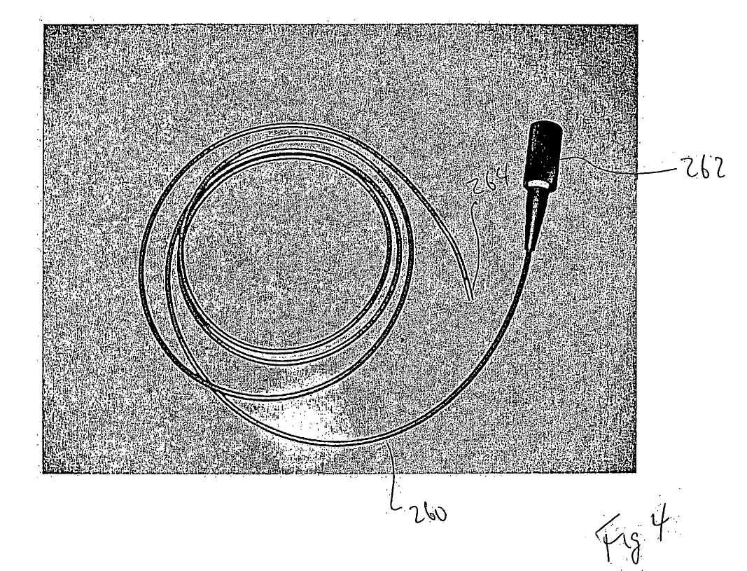

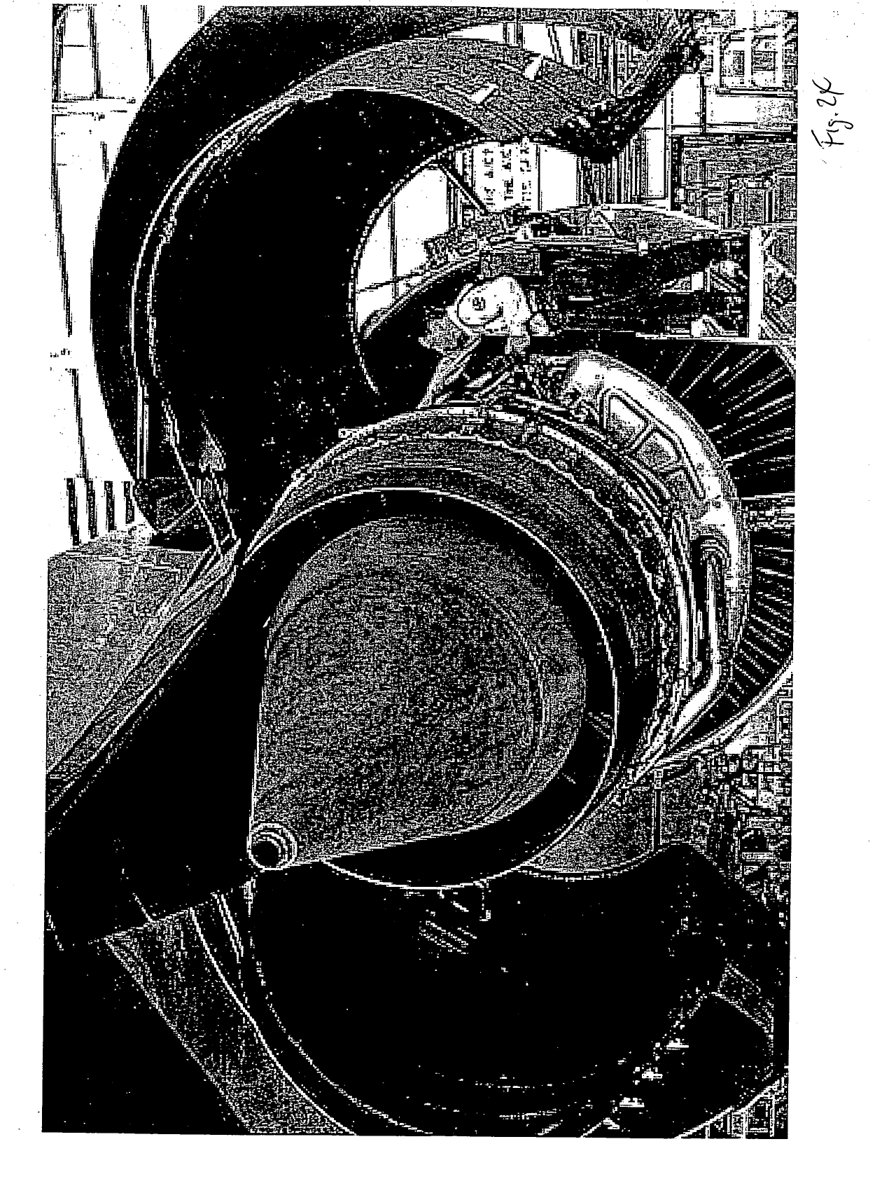

Further as is shown in the embodiment of FIG. 1, the base module 110 has defined in an upper surface thereof an aperture 120 that is designed to accommodate a display module 130. FIG. 1 also shows a unitary device that includes both the display module 130 and a manually operated control module 250, which unitary device is discussed in greater detail below. In addition, the base module 110 has other apertures defined in the upper portion thereof, including aperture 122 that permits passage of a cable (shown in FIGS. 2 and 3) for providing electronic and optical communication between the base module 110 and the unitary display module 130/manually operated control module 250; an aperture 124 that is provided for the passage of an electrical cable 140 for connecting an electrical supply, such as a 110 Volt AC wall socket, with electronic components contained within the base module 110 and described hereinbelow; and an aperture 126 that is provided for the storage of a demountable inspection module such as a flexible probe module or insertion tube (see FIGS. 2 and 4) while a proximal end thereof is attached to the unitary display module 130/manually operated control module 250. The base module 110 also comprises handles 128 that are foldably and/or demountably attached thereto, which handles 128 are provided for the user's convenience in removing the base module 110 from the container module 102 at the user's choice. The base module is configured to operate while situated within the container module 102 or when located outside the container module 102, as the user may find convenient. In some embodiments, the base module 110 comprises one or more hooks or rings to allow for a backpack or shoulder-strap style user aid or other mode of hooking or supporting the base module 110. As an example of such use, see the illustrated backpack usage depicted in FIG. 24. In addition, the base module 110 can comprise strap loops or hooks to allow the base module 110 to be fastened to irregular surfaces or to surfaces that are not flat (e.g., to a tank, a large pipe, a jet engine) by using tie down straps attached to the loops or hooks.

FIG. 2 depicts the base module 102 outside of the container module 102. In FIG. 2, the unitary display module 130/manually operated control module 250 is positioned in a stowed configuration. A flexible probe module or insertion tube 260 is partially shown, with a proximal end of the flexible probe module or insertion tube 260 attached to the unitary display module 130/manually operated control module 250. A cable 270 for providing electronic and optical communication between the base module 110 and the unitary display module 130/manually operated control module 250 is shown with one end attached to the unitary display module 130/manually operated control module 250, the other end having been inserted into aperture 122. FIG. 2 also depicts structures 280 (USB port), 282 (USB port), 284 (Firewire® connector), 286 (Ethernet connector), 288 (IRDA port) and a power switch 290.

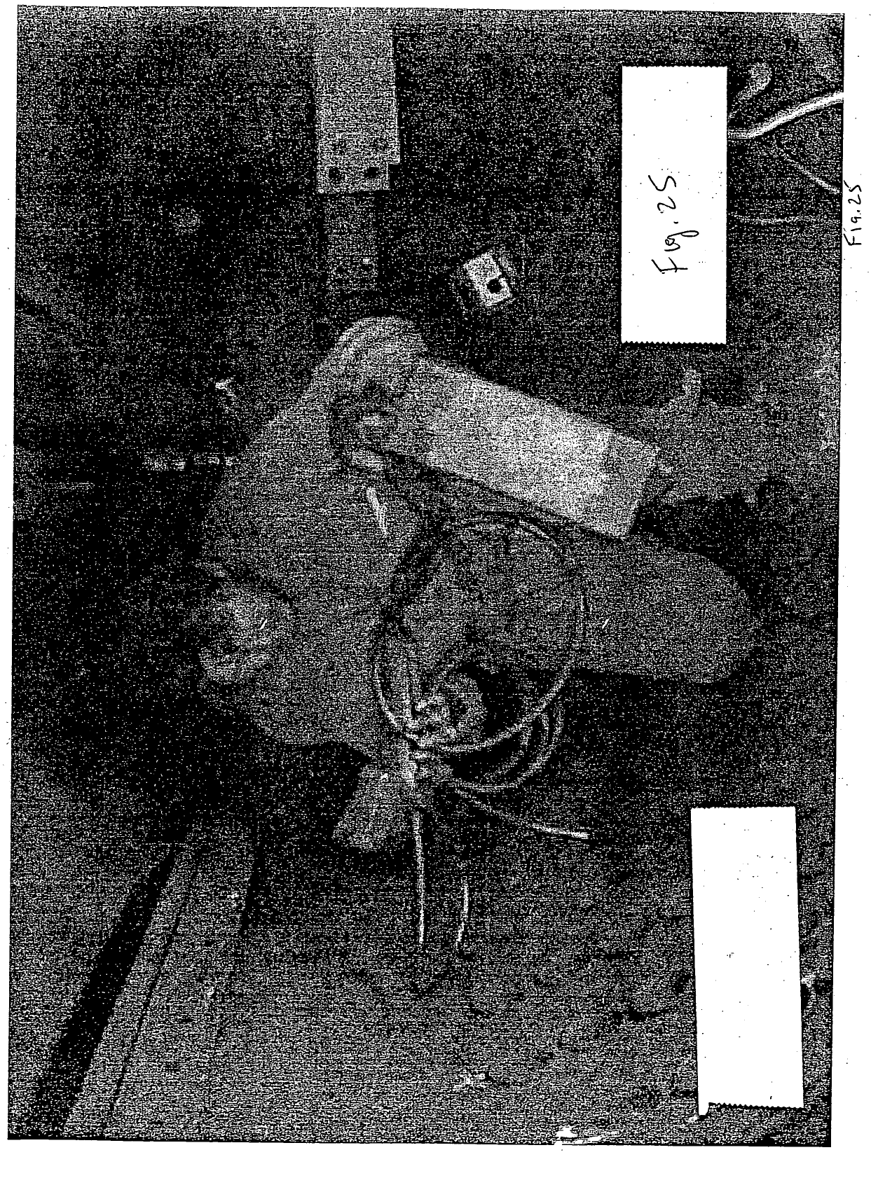

FIGS. 24 and 25 show the problem to be addressed in two situations. In FIG. 24 an individual is shown attempting to inspect internal features of a jet engine. The engine is mounted on an airplane and is situated at such a height that the inspector needs to use a ladder to be able to reach the jet engine. The picture makes clear the advantages inherent in having one's hands free to manipulate the remote inspection device, as well as the need to keep cables short and few in number. In FIG. 25, an inspector is carrying equipment using both hands to support various components of the inspection equipment. In contradistinction to the situations shown in FIGS. 24 and 25, the base module 110 is designed to be easily carried to and within an inspection site, and has been designed to provide a straightforward and ergonomic structure for managing all of the cables and insertion tubes associated with operation of the remote video inspection system. See FIG. 17 and the description given hereinbelow. The base module 110 comprises additional modules that are described and depicted in greater detail hereinbelow, including a computation module (e.g., a computer or CPU and associated electronic components), a light source module (see below) for illuminating a target of interest by way of the cable 270 and the insertion tube 260; and a power module comprising a battery for operating the remote video inspection system in field or remote locations where there is no immediate access to line power sources, such as conventional 110V AC power, and power conversion/charging electronics for recharging the battery and/or operating the remote video inspection system when access to a line power source is possible.

The system has a modular light source, that allows the user to change a light engine (e.g., a lamp, a ballast, and a mounting mechanism) conveniently and quickly. Different light engines can be employed in different embodiments. Light engines that provide white light can be based on LEDs, arc discharge lamps (such as xenon, high pressure mercury, or metal halide lamps) of the type available from Welch Allyn, Inc. of Skaneateles, N.Y., or white laser constructed from red, green and blue lasers. Light engines that provide UV or IR illumination can be based on based on LEDs, filtered arc discharge lamps, or lasers. The light sources are also configurable at the time of manufacture.

In some embodiments, the base module 110 includes an AC output receptacle to permit other accessories to be connected to a source of power. The base module 110 can also comprise one or more outputs for DC voltages, such as 9 volts, 12 volts, or other voltage values for powering external devices that require DC power. The light source module comprises an illumination lamp, such as a xenon arc lamp, that is oriented to enable tabletop or backpack use without affecting light output and color shift by keeping the lamp axis constant or minimizing the deviation in lamp axis angle which results from the base module 110 being oriented in more than one position depending on how it is used (in the container module 102 or in a configuration of a backpack). In some embodiments, the light source can be located in a distal end of an insertion tube, or it can be located in a handset. In some embodiments, the light is an LED. The base module 110 comprises a cooling fan and an optional dust filter to accommodate the thermal loads that the illumination lamp of the light source module presents during operation. The base module 110 is designed to be substantially waterproof.

The base module 110 comprises insulation that shields the user from the battery. The base module 110 comprises a control circuit that causes initiation of an automatic charging mode in which the battery charges when an AC power source is connected to the base unit 110, and that allows “hot” plugging and unplugging of the battery and the AC power source (e.g., the user sees no change in the operation of the system of the invention when a selected one of a battery or the AC power source is connected or disconnected, provided that power is available from some source.) In some embodiments, a “Low battery” indication is provided on the battery and/or on the display module or other user interface. In some embodiments, the base module 110 provides a cooling path for the battery, for example using the base module 110 power supply fan.

The base module is dimensioned to fit within the container module. In the embodiment depicted in FIG. 1 and FIG. 2, one sees upon comparing the drawings that the height of the base module 110, which is moderately greater than the dimension of the keyboard 112 (which is in a stored configuration in FIG. 2), is less than the height of the container module 102, or of the door 108. The lower portion of container module 102 is available as additional storage space, for the spare parts, tools, supplies, documentation and other items that are useful in operating the remote video inspection system 100. FIGS. 2A and 2B are respectively end and perspective cutaway views showing the relative position and orientation of the container module 102, the base module 110, the door 108 and a storage module within the container module indicated by numeral 298. For example, in some embodiments, one or more storage modules in the bottom of the container module 102 are used to store a variety of combinations of parts, such as two probes; one probe and a support, for example, a support having multiple degrees of freedom, including rotation and translation, for holding a unitary display module/controller module in a desired location and orientation (known colloquially as a “magic arm”); one probe and working tools; or one probe and miscellaneous accessories.

The self contained base module 110 includes a probe (or insertion tube) storage reel that can be detachably or permanently attached to the base module 110 or to another portion of the system. The probe storage reel is designed for quick disassembly in the event that it is useful to release the insertion tube from the reel, for example if there should be a problem. In some embodiments, the base module 110 includes controls on the exterior of the base module 110 in addition to controls present in the unitary display module/controller module.

In some embodiments, additional mechanical features of the base module 110 include a protective bumper that reduces impact or shock loads during shipping or during use; and non-skid feet that are raised in the corners, permitting the base module 110 to rest on curved surfaces, as needed, e.g., a large generator or other area. The base module 110 is preferably durable and weather-proof, having a rain-resistant design with no electrical connectors on the top surface thereof and the raised feet on the bottom to prevent contact with surface moisture. In some embodiments, the base module 110 easily accepts a borescope adapter to supply light to a borescope and to receive camera signals. The base module 110 in some embodiments can comprise a pocket or net to allow accessory storage or other general purpose storage when the base module 110 is used in a portable mode of operation.

Display Module

The display module 130 and the control module 250 are provided in a unitary structure. The handset combines the display and control features that are necessary and useful for a user of the remote video inspection system 100 to monitor and control the operation of the remote video inspection system 100 and to observe, evaluate and record the results of an inspection. The handset also provides electrical, optical, mechanical and fluid communication as necessary between the various cables and replaceable probes, which are described herein below in greater detail, that are used in the operation of the remote video inspection system 100. Commonly assigned U.S. Pat. No. 5,373,317 to Salvati et al. describes an embodiment of a unitary device, similar to the handset of the present invention, that includes both a display module and a manually operated control module, and that performs interconnect functions between the cables and replaceable probes of a borescope. U.S. Pat. No. 5,373,317 is incorporated herein by reference in its entirety.

As shown in FIG. 3, the display module 130 in one embodiment is a WVGA (Wide VGA) liquid crystal display (LCD) providing a 16:9 format and high display brightness, with a display quality similar to that of a high definition video display. The display module in other embodiments can comprise other suitable displays, such as, for example, a OLED or a plasma display. According to one embodiment, the display is an LCD with backlighting which may also have reflective properties such as the type commonly referred to as “transflective”. The 16:9 aspect ratio permits both image information as well as other inspection related but non-image information to be displayed simultaneously and separately or all image information (for example: side by side images). The display module 130 is sized to display both an image of the target area as well as other pertinent “off image” information, such as measurement data, system parameters, or user menus. Ideally, the display module 130 is set at a predetermined angle relative to the remainder of the handset to allow the user to more effectively view and use the display module 130 for a variety of use and storage positions. In some embodiments, the system is capable of driving either of a progressive scan display and an interlaced output display. The remote video inspection system 100 in some embodiments comprises one or more auxiliary outputs that can be used to drive an external video display such as a television monitor or computer display. In some embodiments, the display module 130 or an optional external video display can comprise a removable cover or screen useful for removing glare, reflections or other artifacts that comprises an optically active medium such as a filter, an antireflective coating, or a polarizer, the cover or screen being used when the display module 130 or the optional external video display are used in the presence of bright ambient light, such as sunlight, or fluorescent light. The display module 130 can comprise LEDs to provide discrete optical signals to a user, for example, button backlighting or LED on to describe a mode of operation.

Control Module

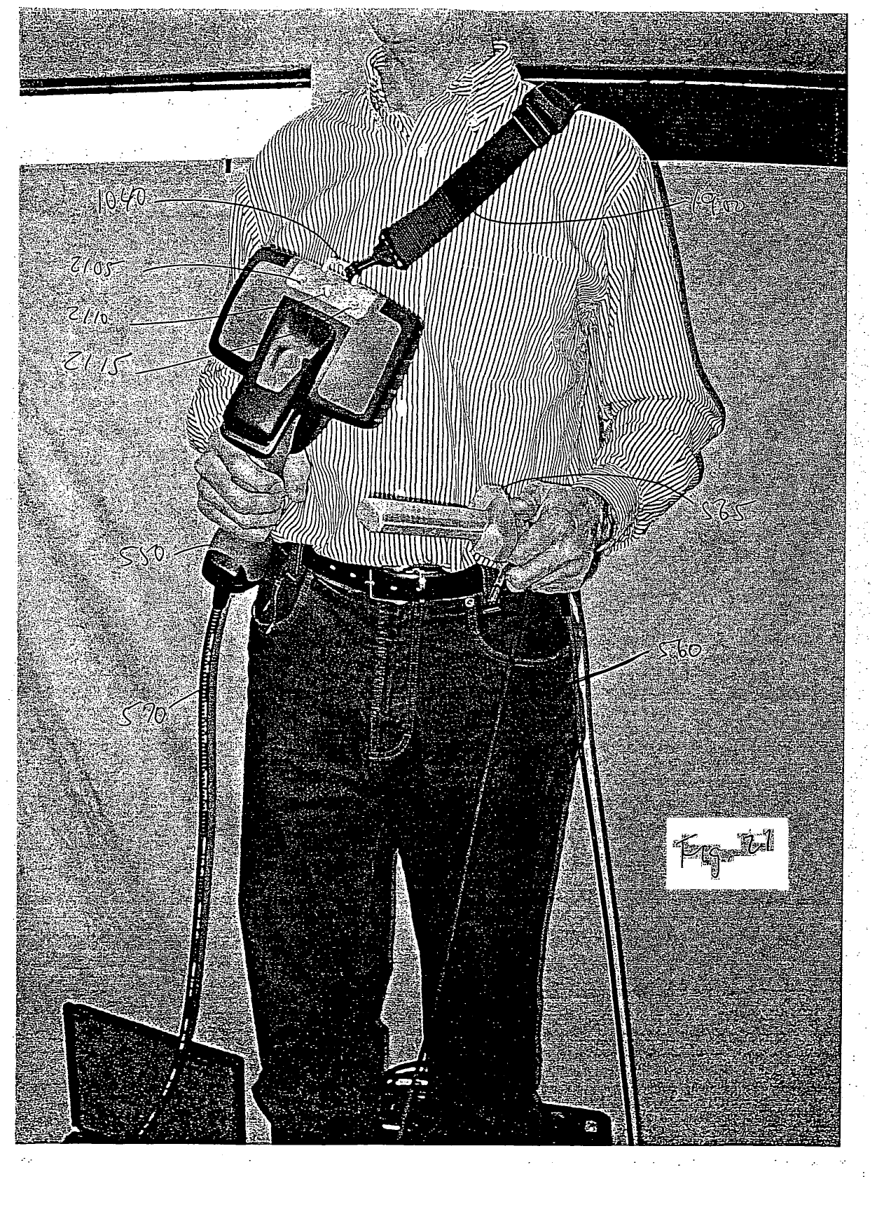

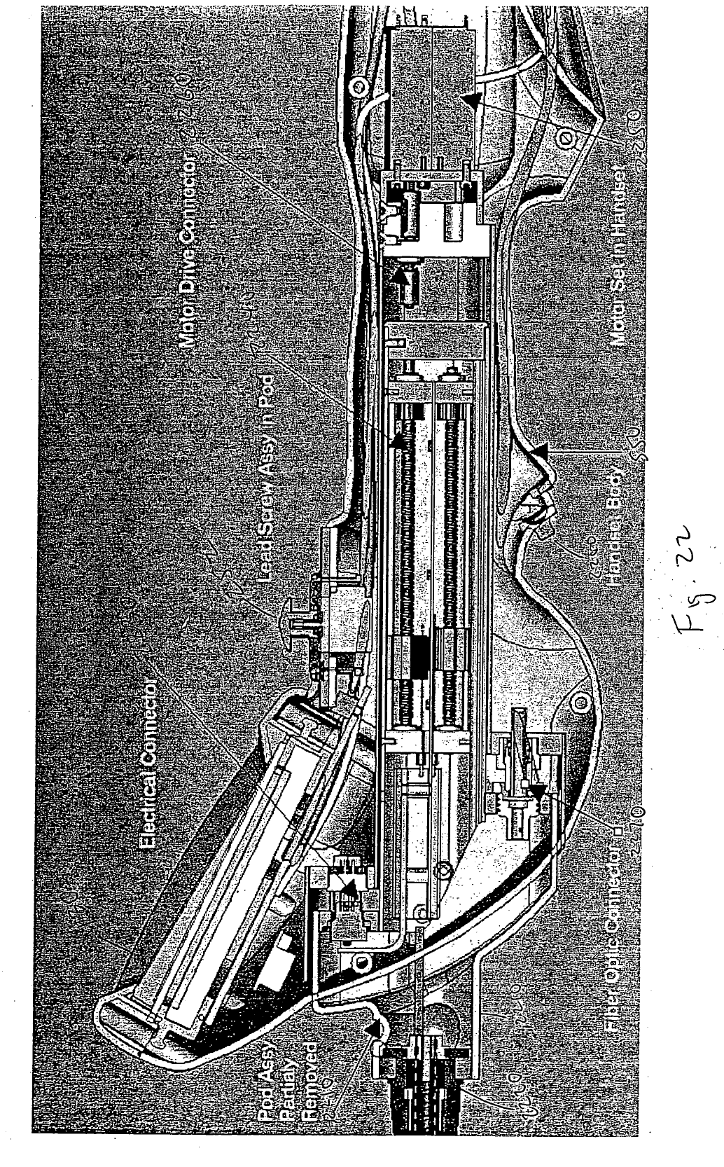

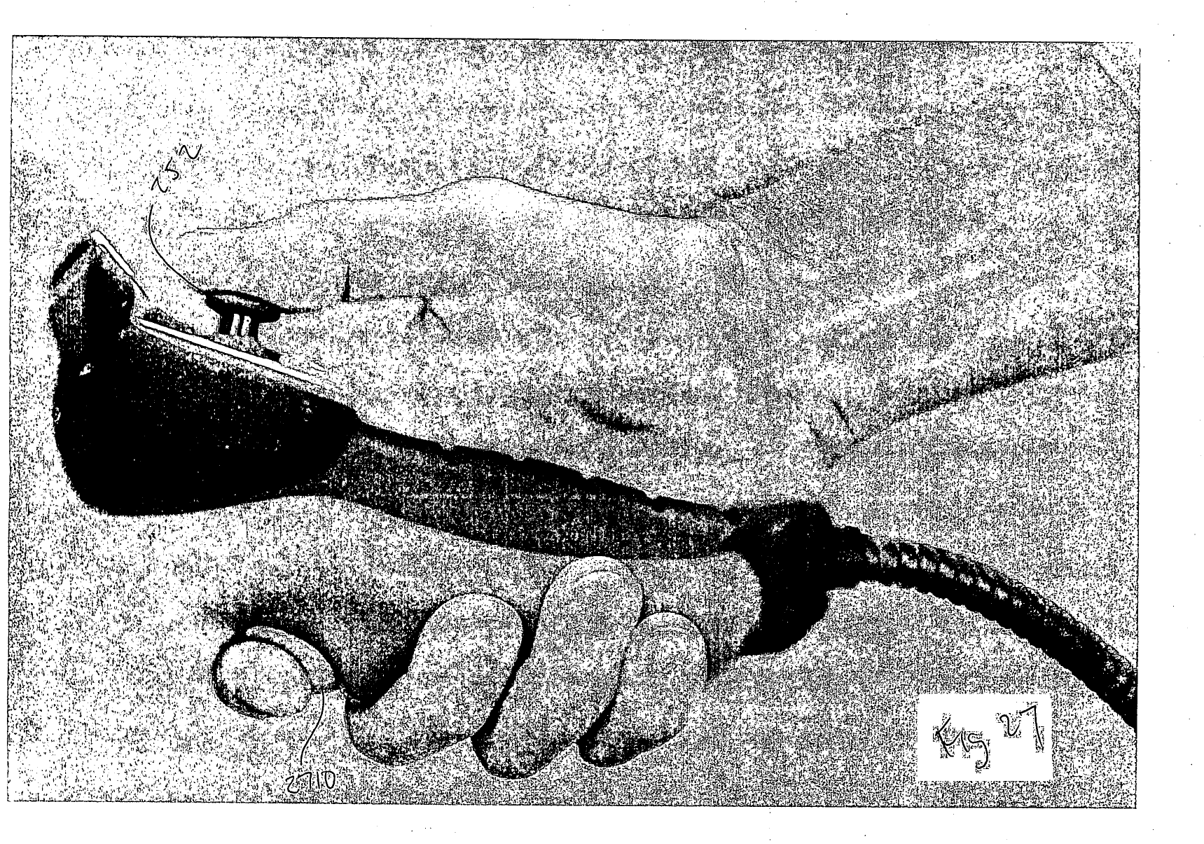

The manually operated control module 250 shown in FIG. 3 comprises a joystick 252 that is used to control the motion of the distal end of the insertion tube module 260 in directions normal to the end of the insertion tube (e.g., “up”-“down” or “y-direction” and “right”-“left” or “x-direction” motion of the distal end of the insertion tube 260). The “up”-“down” and “right”-“left” motion of the distal end of the insertion tube 260 is controlled by servo motors or articulation motors which drive lead screws in a pod assembly, that shown in greater detail and further explained with regard to FIGS. 21 and 22 hereinbelow. The articulation motors are housed in the handset. The leadscrews and their attachment to the articulation cables are housed in the pod. When the pod is inserted into the handset, keyed (e.g., in one embodiment, “D” shaped, or other wise keyed) lead screw shafts engage sockets attached to the motor shafts integral to the manually operated control module 250. The operation of the articulation motors occurs in response to the operation of the joystick 252, for example by application of force by a digit of either hand of the user. Preferably, one servo motor is employed to provide x-direction motion, and one servo motor is employed to provide y-direction motion. By way of example, and considering the joystick 252 as having freedom to move in any radial direction about the center of a circle (which can be represented for purposes of exposition as motion about the face of a clock), if the user pushes the joystick toward a 12 o'clock position the distal end of the insertion tube 260 moves “up”. Equivalently, moving the joystick toward the 3 o'clock position causes the distal end of the insertion tube 260 to move “right”, moving the joystick toward the 6 o'clock position causes the distal end of the insertion tube 260 to move “down”, and moving the joystick toward the 9 o'clock position causes the distal end of the insertion tube 260 to move “left”. The amount of deflection of the distal end of the insertion tube 260 is proportional to the position of the joystick 252 from a central position or “steer and stay” mode which may be a user (or factory) defined programmed relationship based on the radius (magnitude) and angle (direction) of the joystick position such that they dictate speed and articulation direction. Motion of the joystick 252 along radial directions other than the 12, 3, 6, and 9 o'clock directions, such as motion toward the 2 o'clock position, results in motion of the distal end of the insertion tube in a direction that combines two orthogonal (or at least non-collinear) motions, such as “up” and “right.” The joystick includes a press function so that it can be used as a push button or toggle switch. The handset includes a trigger button (not shown in FIG. 3, but see FIGS. 22 and 27) to initiate the capture of image data as well as other system related functions. The trigger button in some embodiments is located on an underside of the handset. The handset also includes direct save and record functions to be selectively executed at the command of a user. In some embodiments, there is provided a toggle switch that freezes an image for capture and manipulation. The toggle switch functions by temporarily inactivating functions such as articulation, for example by temporarily inactivating a control such as the joystick 252, so that accidental motion of the joystick 252 has no effect on the position of the tip of the insertion tube or the camera. When the toggle switch is activated a second time, the controls that were inactivated are returned to their normal functional state.

The system can provide a controlled power down process. In this process, the system responds to a power-off command, such as the de-activation of a power switch, the pressing of a power button, or a selection from a menu. In the power down process, the articulation cables are returned to their center or neutral positions to straighten the end of the probe and/or each of the articulation cables is placed in a slack condition to avoid holding the end of the probe in a bent position. The power down process also shuts down most or all of the system. In some embodiments, the system employs a “smart” articulation cable calibration system. The system has independent control of each cable. The system measures the strain and slack on each cable to balance the load, and the system centers the articulation over the life of the product. This process can be user activated or the process can be caused to happen automatically under control of a computer.

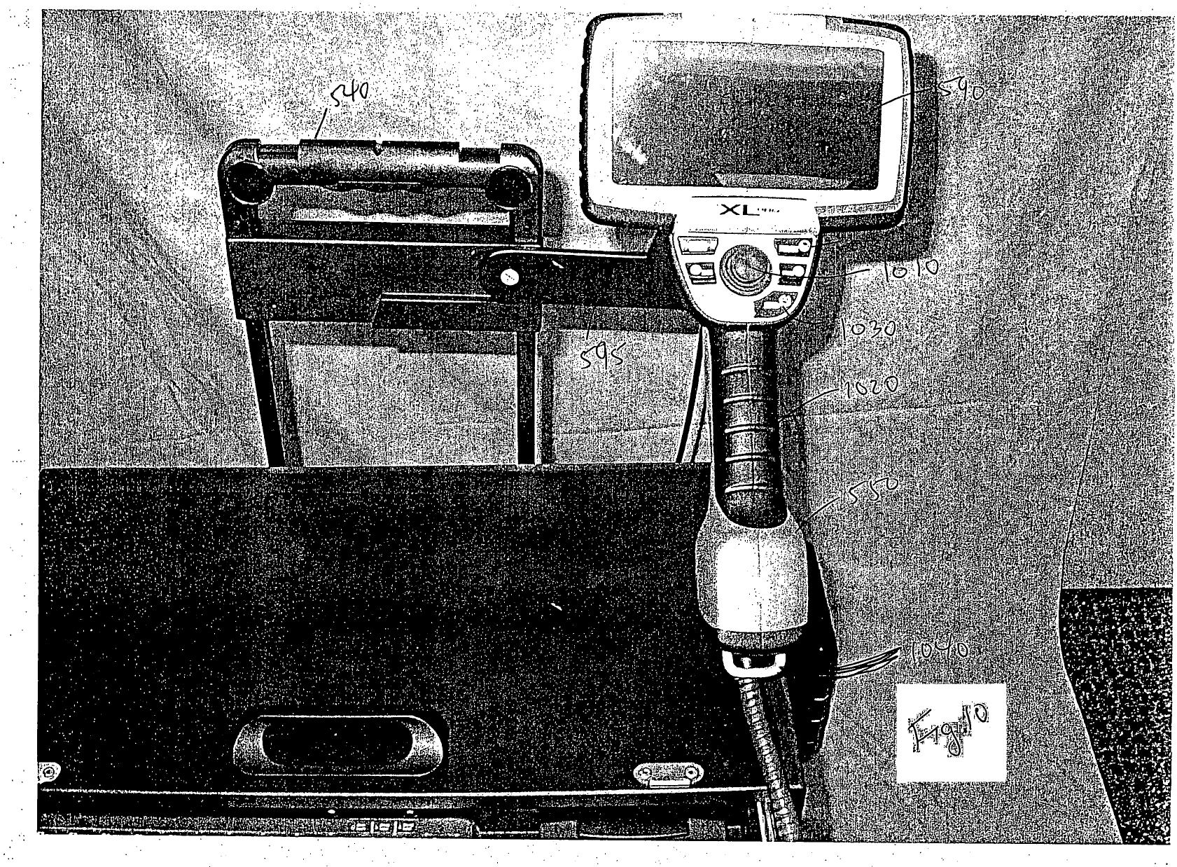

The handset is ergonomically designed such that the grip section is hand-sized and includes a non-slip grip area. Interchangeable insertion tubes for the flexible endoscopic or borescopic probe are provided that can be selectively and interchangeably be connected to the handset. According to one embodiment, manual control 250 comprises articulation motors that are retained in a proximal end of the manual control 250, the articulation motors located so as to provide balance to the handset. The manually operated control module is ergonomically designed for ease and convenience of use by either the right hand or the left hand of a user. In addition, the handset also includes flat areas on a bottom portion to permit the handset to rest on a surface, for example, a table top, the handset further having additional hand clearance at the bottom to aid the user/operator in picking the handset up. The handset in one embodiment includes at least one set of integrated rings for storage hooks or for carrying straps and includes an integrated mounting feature. See FIGS. 10, 15 and 19 and the associated descriptions given hereinbelow.

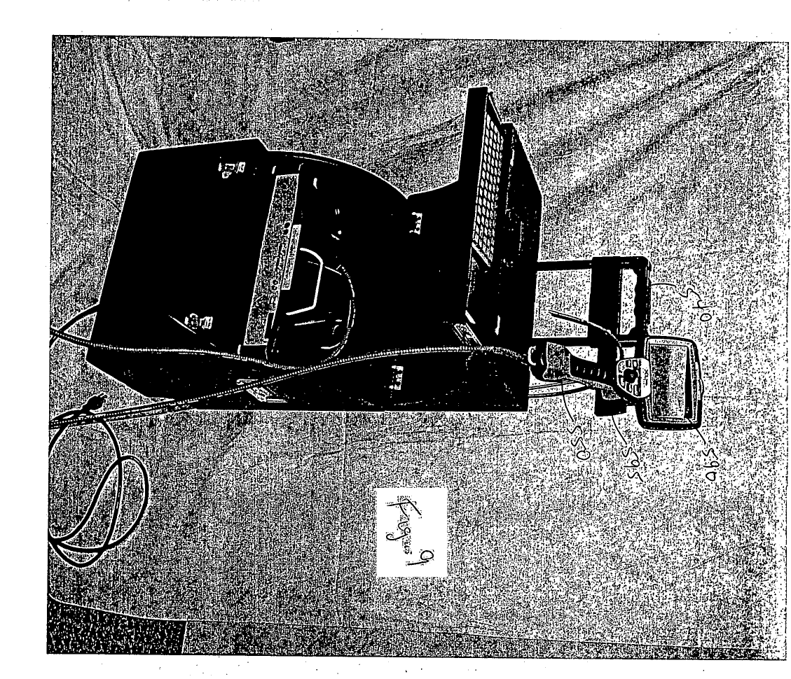

As alluded to above, in some embodiments, the handset comprises an integrated mounting feature that allows the handset to be supported on the extended telescoping handle. See FIGS. 9, 10 and 14 and the associated descriptions given hereinbelow.

The handset comprises a light guide having a large diameter with a bright inner core that provides an optimized optical match and light transfer to a variety of probe light guide having a variety of sizes. The handset in some embodiments comprises a source of illumination to illuminate an inspection port or to illuminate paperwork, for the convenience of and under the control of the user. See FIG. 21 and the description given hereinbelow.

The remote video inspection system can be implemented using light guides of various types. In some embodiments, the light guides comprise a selected one of coherent bundles of optical fibers, semi-coherent bundles of optical fibers (e.g., concentric random bundles that maintain the central lamp hotspot to maximize light output of small bundle probes), and random bundles of optical fibers. In various embodiments, the ends of the bundles are fused, or are epoxied, or the bundles are fused on one end and epoxied on the other. In another embodiment, the light guide is a solid core lightguide, for example comprising plastic or quartz. One preferred embodiment is a semi-coherent fused bundle of optical fibers.

Interconnection Modules and Inspection Modules (e.g., Interchangeable/Replaceable Insertion Tubes)

In the embodiment shown in FIG. 3, the connector 272 connects one end of an interconnection module, such as cable 270, with the handset. The cable 270 provides electronic and optical communication between the base module 110 and the unitary display module 130/manually operated control module 250 or handset. The connector 272 provides sufficient electrical and optical connections to handle bi-directional communication between a computation module housed in the base module 110 and all of the control module 250, the display module 130, and an imaging sensor. The imaging sensor is required for converting reflected light from a target to an electrical signal representative of the reflected light. In some embodiments, the sensor is an imager conforming to the NTSC, PAL, or progressive scan computer video standards. The system includes the capability to generate PAL, NTSC and progressive scan video output formats. In some embodiments, the sensor comprises a lead frame design. In some embodiments, the imaging sensor is situated at a distal end of an insertion tube 260. In other embodiments, the imaging sensor is situated within the handset or within the proximal end of the insertion tube 260. In another embodiment, a general purpose camera, such as an electronic CCD camera, is used to provide troubleshooting diagnostics for the system as well as to create general purpose inspection photos. The general purpose camera is an imager with optics in a configuration different from a conventional insertion tube that is controlled by the DSP that resides in the handset. The general purpose camera can be used to determine whether the DSP circuitry is working in the case of a failure in the pod or in an insertion tube, for example by attempting to observe a feature or scene visible to a user, and also provides general purpose digital camera functionality. Imagers utilizing technology other than CCD (such as CMOS) can also be used interchangeably.

The connector 272 also provides communication of electrical power as needed to the unitary display module 130/manually operated control module 250 to operate the display module 130; and optical communication of light generated at the light source to the target by way of optical fibers in the cable 270, the unitary display module 130/manually operated control module 250, and a insertion tube 260 having an optical transmission path, such as an optical fiber. At the other end of the cable 270 is another connector 274 that connects the cable 270 to the optical light source, to the supply of electrical power, and to the computation module. In some embodiments, the connectors 272 and 274 are threaded connectors or quick connect connectors that make a rugged and secure connection while allowing connection or disconnection with speed and convenience.

In different embodiments, the system can comprise retractable tubes and cords. The mechanism for the retraction can be a slip ring based power cord, umbilical cord or insertion tube. The system will retract the power cord, signal cables, light guides, and/or the articulation tube using the slip ring mechanism. A user can pull out the length required for the application at hand. Upon completion of the inspection system activity, the user can activate a cord or tube retraction or rewind feature. Each cord or tube may have a separate handle or automated return mechanism that the user can activate to stow the cord/tube. The return mechanisms may be powered by springs or motors as appropriate.

It is desirable to minimize the number of conductors in cable 270 for size, weight, and reliability reasons. In a preferred embodiment, cable 270 comprises high speed serial digital links which connect base module 110 and unitary display module 130/manually operated control module 250. Digital video data, generated in one embodiment by a video DSP in 130/250, is input into a serializing IC, such as the National Semiconductor DS92LV16 in a parallel format, such as ITU-R BT.656 (hereinafter “BT.656”). BT.656 is the international standard for interconnecting digital television equipment operating to the 4:2:2 standard defined in ITU-R BT.601. It defines blanking, embedded sync words, the video multiplexing formats used by both the parallel (now rarely used) and serial interfaces, the electrical characteristics of the interface and the mechanical details of the connectors. The digital video signal is typically generated using a high frequency video clock operating in the megahertz range. Other high frequency signals that are sent to the serializing IC include a serial data signal, and a synchronization signal. The serializing IC also receives a communications signal from a microcontroller which monitors user inputs. The serializing IC latches the data on its parallel inputs on the rising edge of the video data clock. It then serializes the video, audio, and communication data for transmission to base module 110. In some embodiments, it is useful to use a minimal number of conductors for data transmission. In a preferred embodiment, a single twisted pair of electrical conductors or an optical fiber is used to transmit the serialized information. In the base module 110, a deserializer receives the serial data signal, recovers the video clock, and outputs the original parallel signals in parallel format. In a similar manner, video data for the display module 130 along with communications data being sent from base module 110 to unitary display module 130/manually operated control module 250 can be sent on a minimal number of conductors. The serializer and deserializer functions are often contained within a single IC simplifying the implementation of the serial link.

The clock generation and synchronization of all the video devices is a challenging problem because in some embodiments, the system has multiple inputs and multiple displays all having different pixel clock rates. In one embodiment, a 27 MHz clock is required for a video encoder for generating the s-video output. When the s-video input is being used, a 27 MHz clock frequency is output from the video decoder which performs the A/D conversion on the s-video signal, but can vary somewhat in frequency. A timing generator in the unitary display module 130/manually operated control module 250 generates the CCD imager clocking signals. When a PAL s-video output signal is desired, a 28.375 MHz clock is needed by the timing generator. When an NTSC s-video output is desired, a clock frequency of approximately 34 MHz is required. The LCD display in the display module 130 requires a clock frequency of 34.6 MHz or less. Additionally, most LCD displays require at least 18 bits of color data, one bit each for horizontal and vertical synchronization signals, one bit for an active video signal, one bit for an active video signal, and one bit for the video data clock for a total of 22 parallel bits of data. Few if any serializers and deserializers available today can accept more than 18 bits of parallel data for output on a single twisted pair cable. The invention contemplates that when serializer/deserializer ICs having sufficient capacity are available at an economical price, those devices will be employed. However, implementations using serializer/deserializer ICs with fewer bits, such as 16 or 18, are possible by using higher parallel clock rates and using more than one clock cycle to convey the data needed for each LCD pixel. In one embodiment, a master clock in base module 110 is switchably provided by a 27 MHz reference clock (used when the s-video input is inactive) and the 27 MHz video decoder clock (used when the s-video input is active). This master clock is input to a programmable clock generator, such as the Integrated Circuit Systems ICS307-02 IC. The clock generator is programmed to generate an output clock having a frequency of twice that needed by the CCD timing generator (2×28.375 MHz=56.75 MHz in PAL mode, 2×34 MHz=68 MHz in NTSC mode). Data for each pixel of the LCD display of display module 130, which is output by a processor in base module 110, requires 2 clock cycles for each LCD pixel. This allows the 22 bits of LCD video data to be divided into 2 segments, each segment comprising no more than 18 bits, which is accepted by the serializer IC. For example, in one embodiment, each segment comprises 11 bits, allowing the use of presently-available serializers. This data transmission protocol provides as many as 14 additional unused input bits (e.g., 2×18=36 available bits, less the 22 bits needed for data transmission) so that the serializer can accept a communication signal for transmission to a microcontroller in the display module 130. The deserializer in unitary display module 130/manually operated control module 250 receives this data and recovers the 56.75 MHz or 68 MHz output clock. Circuitry in display module 130 re-combines the deserializer parallel data output on sequential clock cycles to form the 22 bits of data needed by the LCD display. A clock divider divides the 56.75 MHz or 68 MHz recovered clock by 2 to generate, respectively, a 28.375 MHz or 34 MHz clock which is used to clock data into the LCD and to drive the CCD timing generator circuit. The video data output by the DSP in unitary display module 130/manually operated control module 250 is output at this same frequency and is used to drive the serializer in unitary display module 130/manually operated control module 250 which sends the camera video, microphone audio, and communications data back to the base module 110. If the programmable clock generator cannot generate the exact frequency needed to keep the internal system devices synchronized to an external source, the clock generator is re-programmed periodically to slightly adjust the system clock frequencies to maintain synchronization. This approach minimizes the number of clock generators needed by the system, allows synchronization of the system to external sources, allows the generation of PAL (25 frames/sec) or NTSC (30 frames/sec) frame rates with one hardware set, keeps all internal video devices synchronized, and allows two low cost twisted pair cables in module 270 to transport audio, video, and communications data in digital format bi-directionally with none of the degradations associated with analog transmission and without the many conductors that would be needed for the transmission of parallel digital data.

FIG. 4 shows an inspection module (insertion tube 260) that is readily interchanged for another inspection module, for example, a second replacement insertion tube 260 to be used when a user detects a problem in the use of first insertion tube 260, or a second replacement insertion tube 260′ that has a different diameter, a different length, or a different stiffness as compared to the first insertion tube 260. The insertion tube 260 is connected to the display module 130 by use of a connector 262 that provides electrical and optical connections to handle all of the following communications: optical communication of light generated at the light source to the target by way of optical fibers in the cable 270 via the unitary display module 130/manually operated control module 250 to the insertion tube 260 having an optical transmission path, such as an optical fiber, for illumination of a target; and a selected one of a communication of reflected light from the target to a sensor 300 housed in the unitary display module 130/manually operated control module 250, and a communication of electrical signals to and from a sensor 310 situated at a distal end of the insertion tube 260. The electrical signals obtained from either of sensor 300 or sensor 310 are representative of light reflected from a target. The connector 262 also communicates electrical control signals communicated between the unitary display module 130/manually operated control module 250 and the sensor 310 as necessary. The connector 262 is a threaded connector or quick connect connector that makes a rugged and secure connection while providing speed and convenience in making the connection or disconnecting the insertion tube 260. In some embodiments, the insertion tube 260 comprises a replaceable tip 264, for example a thread-on tip that can be attached or removed. Replaceable tips and a tool useful for performing the replacement are described in co-pending commonly assigned U.S. patent application Ser. No. 10/656,738, which application is hereby incorporated by reference in its entirety herein.

In some embodiments, the remote visual inspection system has the ability to track and to log the motion of the tip of an insertion tube in three dimensions, such as in orthogonal coordinates such as the x-, y- and z-directions of a conventional Cartesian coordinate system. The motion of the tip can be calculated by observing the angular orientation of the tip at an instant in time and monitoring the amount by which an insertion tube is advanced or with drawn in a brief interval immediately thereafter. With current motion sensors and analog-to-digital converters, such measurements can be performed with cycle time of milliseconds of less. By deducing the location of the tip of an insertion tube at a specified time, various useful functions can be implemented, including such functions as identifying a location in three dimensional space of an artifact that is observed; identifying a location so that later observations at the same location can be performed; identifying a location so that another observation of the same location from a different direction or path of access can be performed; and correlating a location with an image.

As to the interchangeable probes or insertion tubes 260, the articulation cables extending from the handset are preferably made at least partially from tungsten to improve articulation performance and reduce stretch of the articulation cable material. In an alternative embodiment or optionally, the handset is coupled in fluid communication with the insertion tube 260, so that the insertion tube 260 is articulated by pneumatic or hydraulic pressure applied by way of the fluid. The insertion tube 260 comprises a double braid construction to enable small bending radii, and hence small diameter storage. In some embodiments, the inner braid is provided to control the stiffness of the probe. Probes may be designed and constructed to vary in stiffness by controlling the relative angle between the strands forming a braid layer. The use of two braided layers can in some instances also provide improvements in shielding EMI.

The probes selectively and interchangeably interface with the handset by means of a positive locking mechanism in order to prevent accidental release thereof. Preferably, a wide range of diameters are available for use in the interchangeable probes to fit a wide range of applications and permitting a variety of diameters.

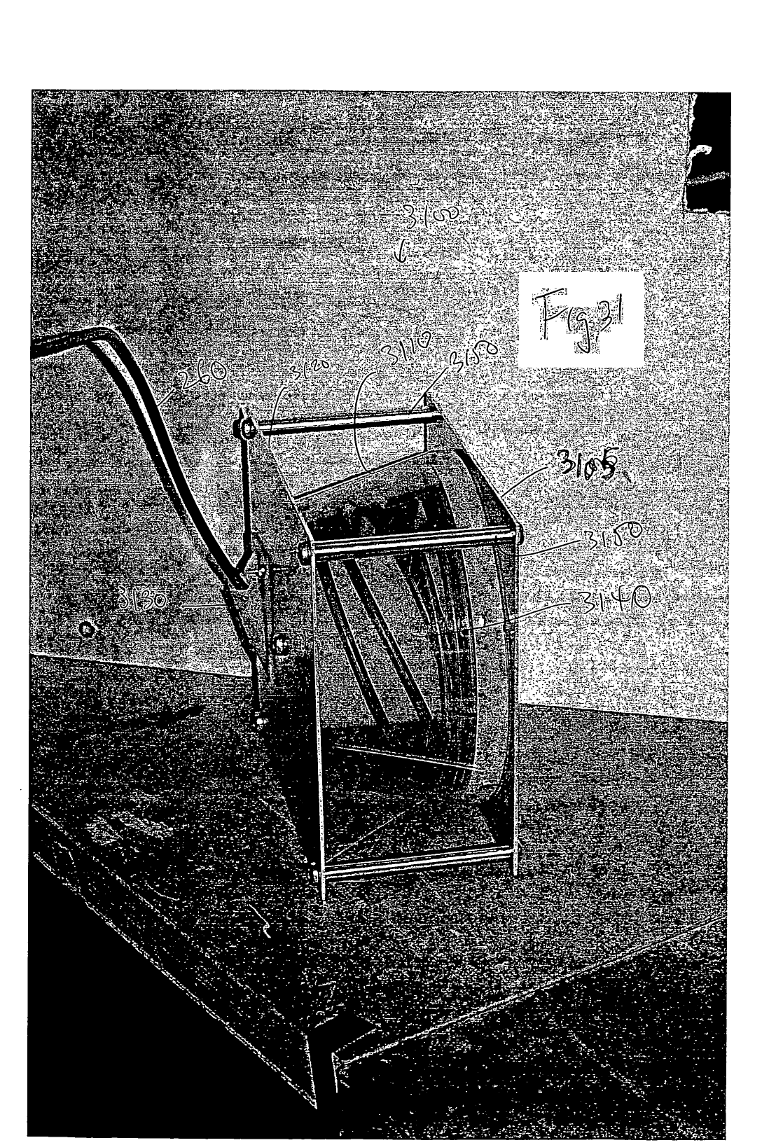

In some embodiments, the replaceable probe 260 is stored in coiled form on a reel. A reel is stored in a container or case that is attachable to the base module 110 and is removable with the base module 110 from the container module 102. In an alternative embodiment, the reel can be left in the container module 102. A spare reel can be provided to handle additional diameters of replaceable probe 260. By using more than one reel, there can be multiple probes provided in a single container module 102. In some embodiments, the reel is a push-in style reel, such that there is no need to hand wind a probe or to reel up a probe, but merely to push in a deployed length of a probe into a reel from storage. FIG. 31 illustrates an embodiment of a reel 3100 useful for storing an insertion tube 260. In FIG. 31 there is shown a reel 3100 comprising end plates 3105, 3120 that support a rotating container configured to hold an insertion tube 260. An inner surface 3140 of the rotating container is configured to support a length of insertion tube in a circularly or helically wound configuration. An external surface of the rotating container 3110, which in one embodiment comprises a transparent material such as a plastic, is configured to constrain the insertion tube within a volume such as a right circular cone or a right circular cylinder. The reel 3100 comprises an entryway 3130, which in the embodiment depicted is a tubular entry fixed to an external surface of an end plate 3120 of the reel in registry with an opening defined in the surface of the endplate 3120. The entryway is conveniently fastened to the end plate 3120 with any conventional fastener, such as screws. The reel is conveniently assembled by stacking the required components and holding the endplates in place with fasteners, such as bolts and nuts 3150. The rotatable portion (e.g. rotating container) of the reel 3100 is held by mating rotational guides fixed about a rotation axis of the rotatable container to the surfaces of end plates 3105, 3120 facing the rotatable container. The rotational guides are not shown in FIG. 31, but are of conventional construction.

System Software

The system can contain, save and display third party documents for use either with the inspection process or for instructing the user about the system. The system can be additionally configured into a network. The system provides the ability to communicate and send inspection-related information to an on-line database (i.e., an engine inspection record database, or an electronic medical records (EMR) database), or to send real-time video to an expert situated at a different location for review and feedback.

In some embodiments, the system of the invention can display third party documents to a user. The documents can comprise information relating to the operation of the system of the invention (such as user manuals for third party components or software employed with the system), information relating to the object to be inspected, or other third party documents, such as maps showing the location of the object to be inspected or directions and instructions for reaching or obtaining access to the object to be inspected. The documents can be in any of a variety of formats, including text such as ASCII text, images such as JPEG, TIFF or other well known image formats, formats that are defined by third parties but that are used with permission, such as use of the Adobe Acrobat™ Reader and the use of the PDF file format (used under the license posted on the website at http://www.adobe.com/products/eulas/pdfs/Gen_WWCombined_Languages_{—}8.9.01_{—}11.14.pdf), or file formats generated by any of a variety of word processors such as Microsoft Word™, Corel WordPerfect™, Sun StarOffice Writer™, and other commercially available word processing programs.

In some embodiments, the system of the invention comprises a report generation module, such as software that can use the data obtained during an inspection of an object to create a report. The report generation module comprises a user interface module that receives input from a user by way of a keyboard or keypad, a pointing device such as a mouse or joystick, and/or a speech recognition system such as a microphone and speaker and associated speech recognition software and speech synthesis software. The report generation module can generate a report that comprises one or more of text, figures or images, tables, graphs, and data files. The report generation module can receive commands from a user, or can receive formatting commands from a defined format source such as a database, regarding the formatting or display of the elements of the report. The formatting commands can include for example, size, color and font of textual material; size, color and resolution of figures or images; parameters to be used in constructing tables; types of graphs (e.g., line, scatter plot, histogram, pie chart, 2-D, or 3-D format) and properties thereof such as fonts, symbols, axis identifiers, series identifiers or keys and the like; and a format of a datum, units in which a datum is to be expressed, and a sequence in which a series of data are to be presented in a data compilation. As described hereinabove, the system of the invention can publish a report by displaying it to a user, by sending it to another repository by way of an electronic or optical communication for later display or printing, or by delivering or displaying the report remotely by way of a communication link such as a hard-wired connection, a wireless connection, or communication over a network such as the Internet, a satellite communication network, or a radio/television communication network.

In some embodiments, the system of the invention comprises a distortion correction module. The distortion correction module can be a software-based module or a hardware-based module. The distortion correction module comprises one or more submodules that manipulate image data obtained by the remote video inspection system 100 to remove distortions relating to size, angle, non-linearity, color rendition, contrast, focus, aliasing, unevenly-distributed illumination, and optical color separation, and to correct or remove artifacts produced in an image by features of the system itself, such as the well known pincushion distortion introduced by use of a fisheye lens. In some embodiments, the distortion correction module can determine the identity or type of insertion tube tip that is present, and can apply a distortion correction appropriate to the identified type of tip.

In some embodiments, the system of the invention comprises user defined menus. The user-defined menus are generated by software in response to user prompts, for example by changing the default display of a pull-down menu system to display the items that a user considers to be the menu items most important or most often used in a specific inspection operation, in the preparation of a report, in setting up the system for operation, or in other aspects of the operation of the system, such as communication with a remote system or a remote database. The user-defined menus can include menu items that are pre-programmed into the system, as well as items that the user specifically codes into the system, for example by defining the action of the function keys of a computer keyboard, or by defining a combination of keys, such as the simultaneous activation of the “Alt” key and a specific letter or number, to activate a specific menu command. The user can also define a macro or sequence of button activations, joystick motions, and/or menu functions to achieve a desired function that can be mapped to a specific button or menu function.

Referring to FIGS. 5-23, there is illustrated a remote video inspection system in accordance with a second embodiment of the invention. In brief, the system herein also utilizes a case that includes a self-contained base unit that can be removed from the base, the base unit including a light source, battery, and a handset that is tethered to the portable hand-held base unit.

FIG. 5 illustrates features of a second embodiment showing the system in front view. The system comprises a container module 502 having a body 504 and lid 506 connected by hinges, with a base module 510 resting in a cavity defined in the body 504 of the container module 502. A pull out shelf 520 attached to the lid 506 has resting thereon a keyboard 530. The keyboard 530 is a keyboard such as is used with a conventional personal computer. The keyboard 530 can in different embodiments be a wireless keyboard, such as a keyboard that can communicate using infrared or electromagnetic waves, or a keyboard connected to the system with a multiconductor electrical cable. An extended telescoping handle 540 is shown in an extended position. A handset 550 is shown resting on the base module 510, with associated insertion tube 560 and cable 570. Handles 580 are provided on the base module for carrying the base module 510 and to provide a “nest” for the insertion tube 560 and the cable 570.

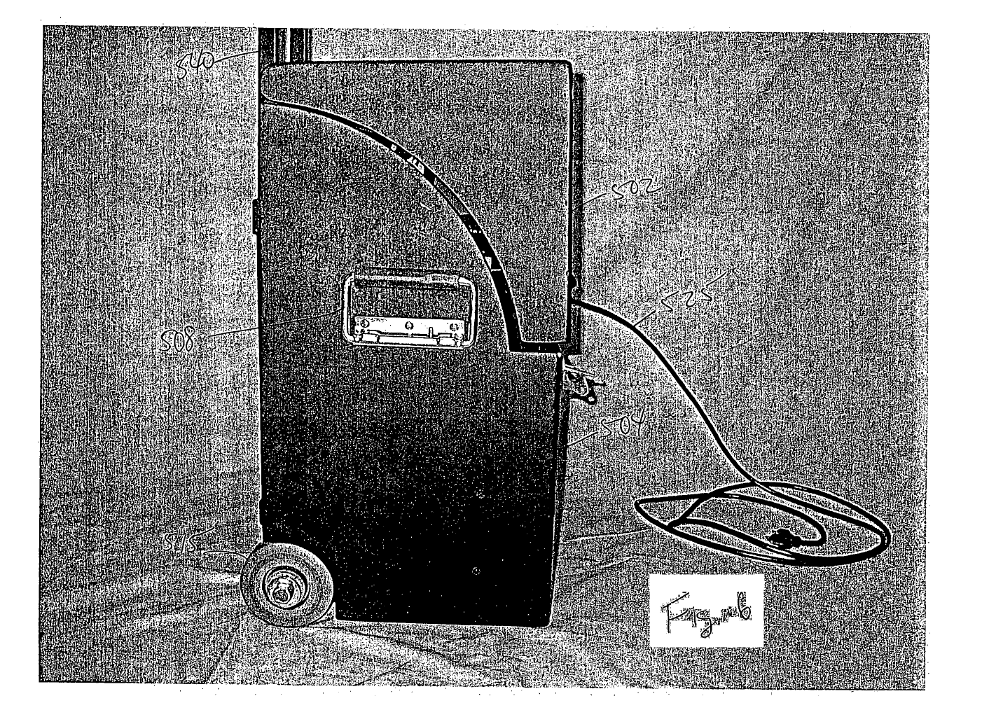

FIG. 6 illustrates features of a second embodiment showing the system in a side view. The side view depicts the system case module 502 in essentially closed configuration, in which the lid 506 is nearly closed over the base module 510, that is not visible, and nearly in registry with a periphery of the body 504 of the container module 502. Also visible in FIG. 6 are a handle 508 attached to a side of the container module 502, which handle 508 is in a folded configuration; a wheel 515 attached to a lower corner of the container module 502; and an electrical cord 525 for connecting the system to an AC electrical power supply.

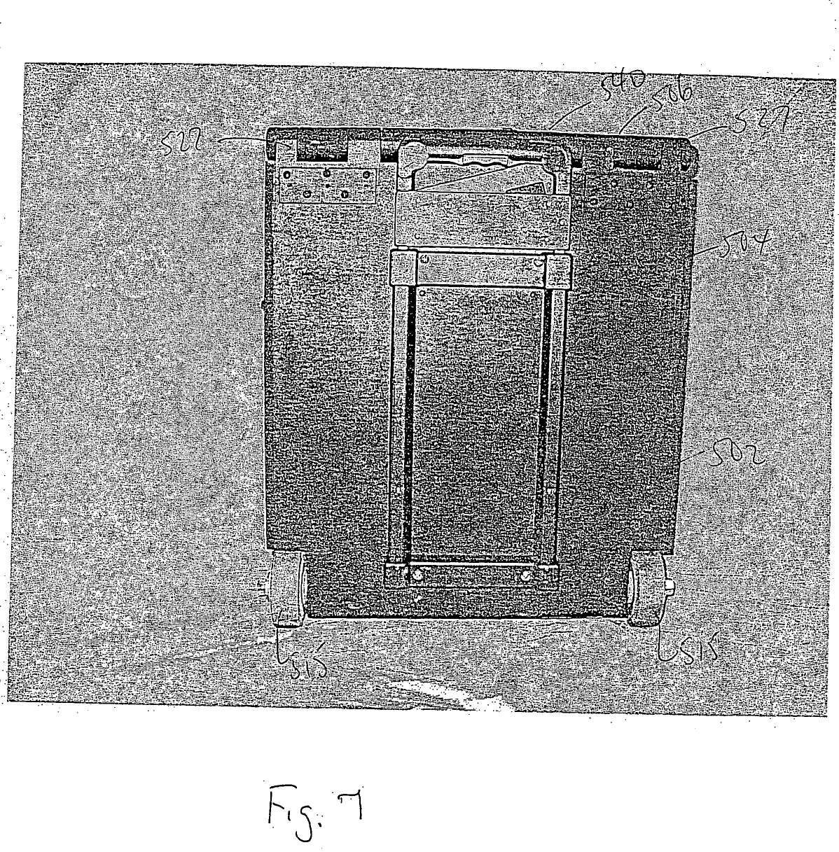

FIG. 7 illustrates features of a second embodiment showing the system in a rear view. In the rear view, one can observe the extendable telescoping handle 540 in a stowed configuration. Two wheels 515 are shown in the lower corners of the rear of the container module 502. Hinges 527 are provided to connect the body 594 and the lid 506.

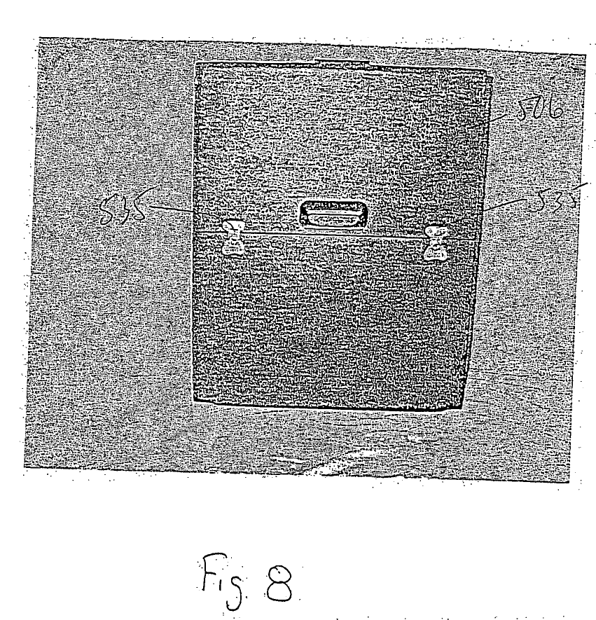

FIG. 8 illustrates features of a second embodiment showing the system with the container module closed. In FIG. 8, the container module 502 is viewed from a front direction, and there are two latches 535 provided for securing the lid 506 in a closed position.

FIG. 9 illustrates features of a second embodiment showing the system in a perspective view. Many of the features shown in FIG. 9 were previously described with respect to FIG. 5, and will not be repeated again. In FIG. 9, the handset 550 is shown with the display 590 visible, and with the handset 550 supported by a bracket 590 that is attached to the extended telescoping handle 540. FIG. 10 is a close-up view of a portion of the view of FIG. 9 from a slightly different perspective. In FIG. 10, the joystick 1010, the non-slip surface 1020 of the handle 550, and activation buttons 1030 are visible on the handset 550. In addition, rings 1040 are provided at the ends of handset 550 for use in supporting handset 550 from a shoulder strap or a harness, so that the user need not maintain a grip on the handset 550 at all times, while still having the handset 550 close by for use as needed.

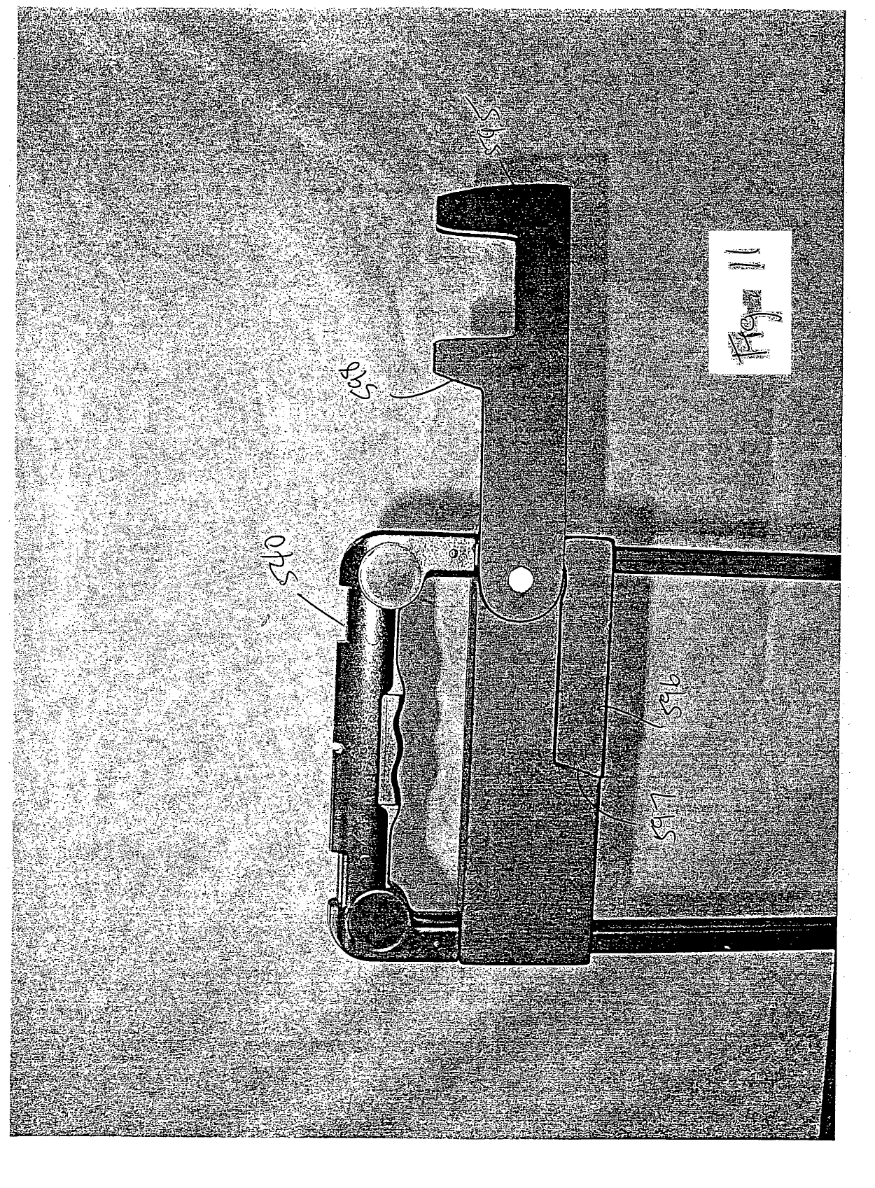

FIG. 11 illustrates features of a second embodiment showing a close-up view of an extended telescoping handle 540 and a support bracket 595. The support bracket 595 is attached rotatably to the telescoping handle 540 by a bolt or a rivet, so that the support bracket 595 can be extended in a first position (as shown) when needed, and stowed in a second position when not needed for use. As shown in FIG. 11, the telescoping handle 540 comprises a stop 596 and a surface 597 that mate with a corresponding surface 598 of the support bracket 595 when the support bracket is situated in the second, stowed position.

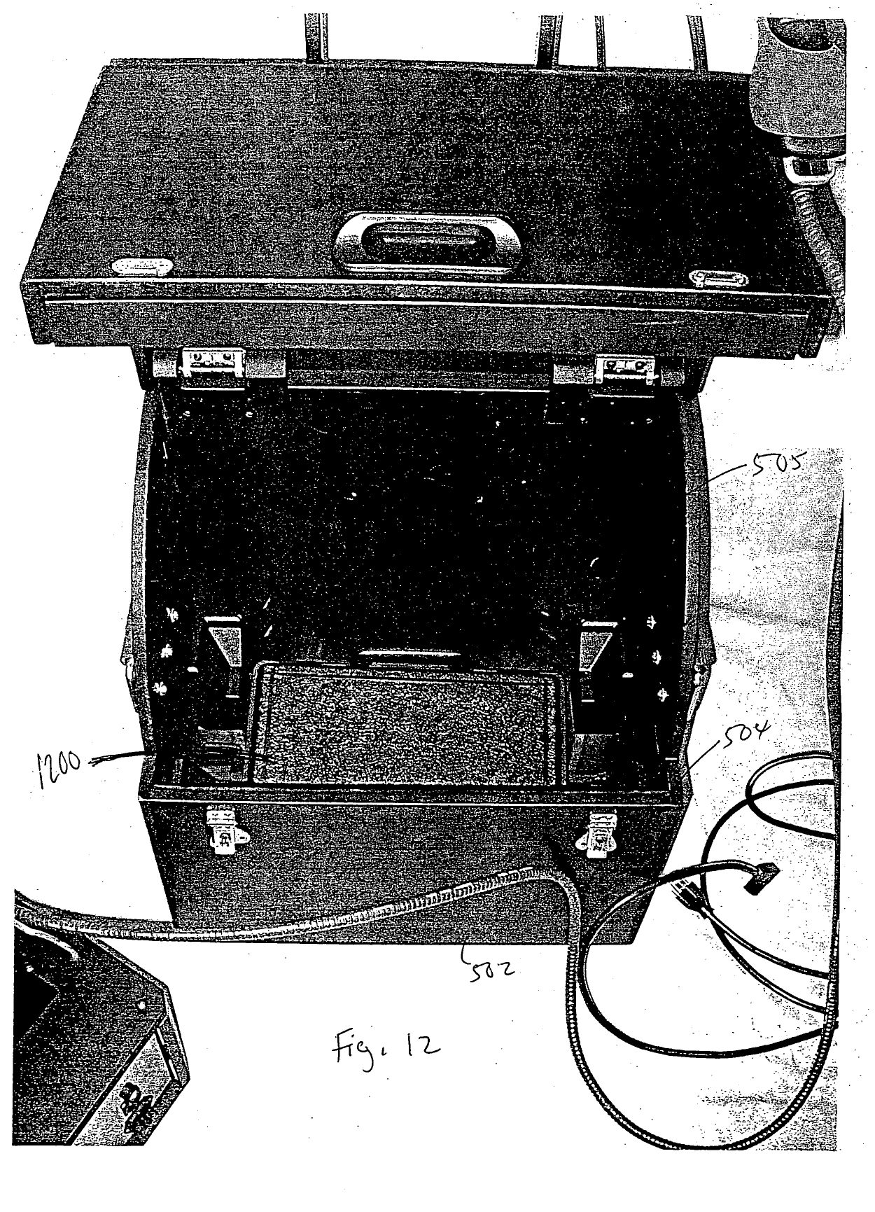

FIG. 12 illustrates features of a second embodiment showing the container module 502 after the base module 510 has been removed. The body 504 of the container module 502 defines a cavity 505 wherein parts, supplies, and other useful items can be stored. In FIG. 12, a case 1200 is visible in the bottom of the cavity 505 of the body 504.

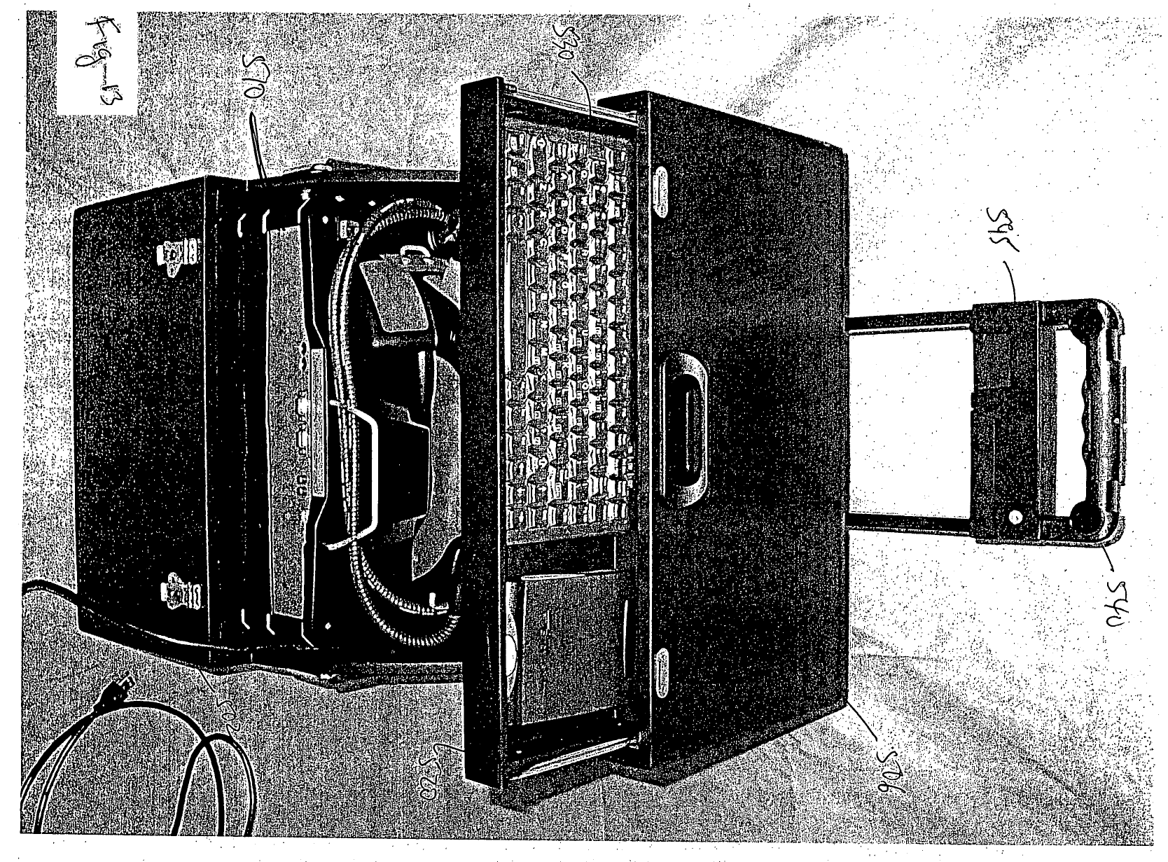

FIG. 13 illustrates features of a second embodiment, showing a system with a keyboard 530 in a pull-out shelf 520. FIG. 13 is an illustration that is similar to that shown in FIG. 5, and will not be discussed in significant detail. As is shown in FIG. 13, the pull out shelf 520 has defined therein a space large enough to contain both the keyboard 530 and additional items, such as a note pad, small parts, or the like.

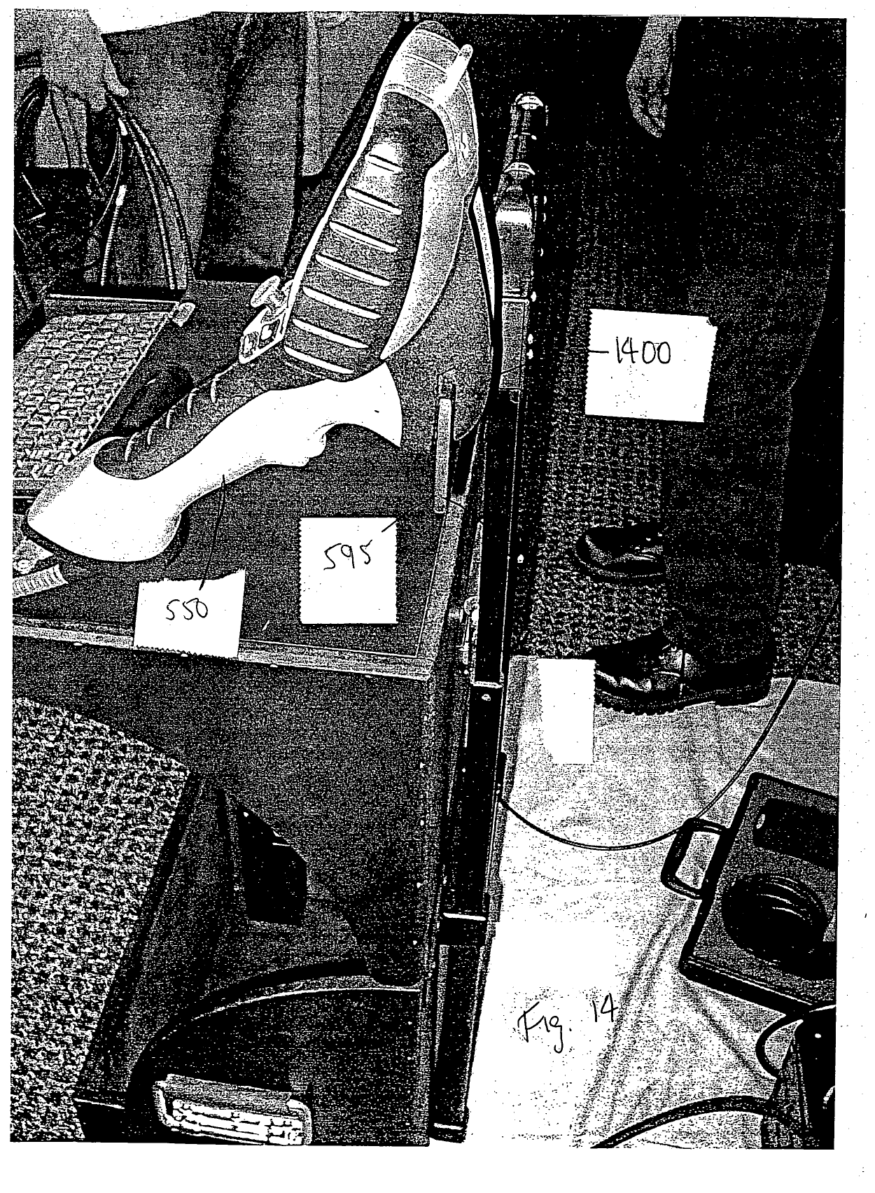

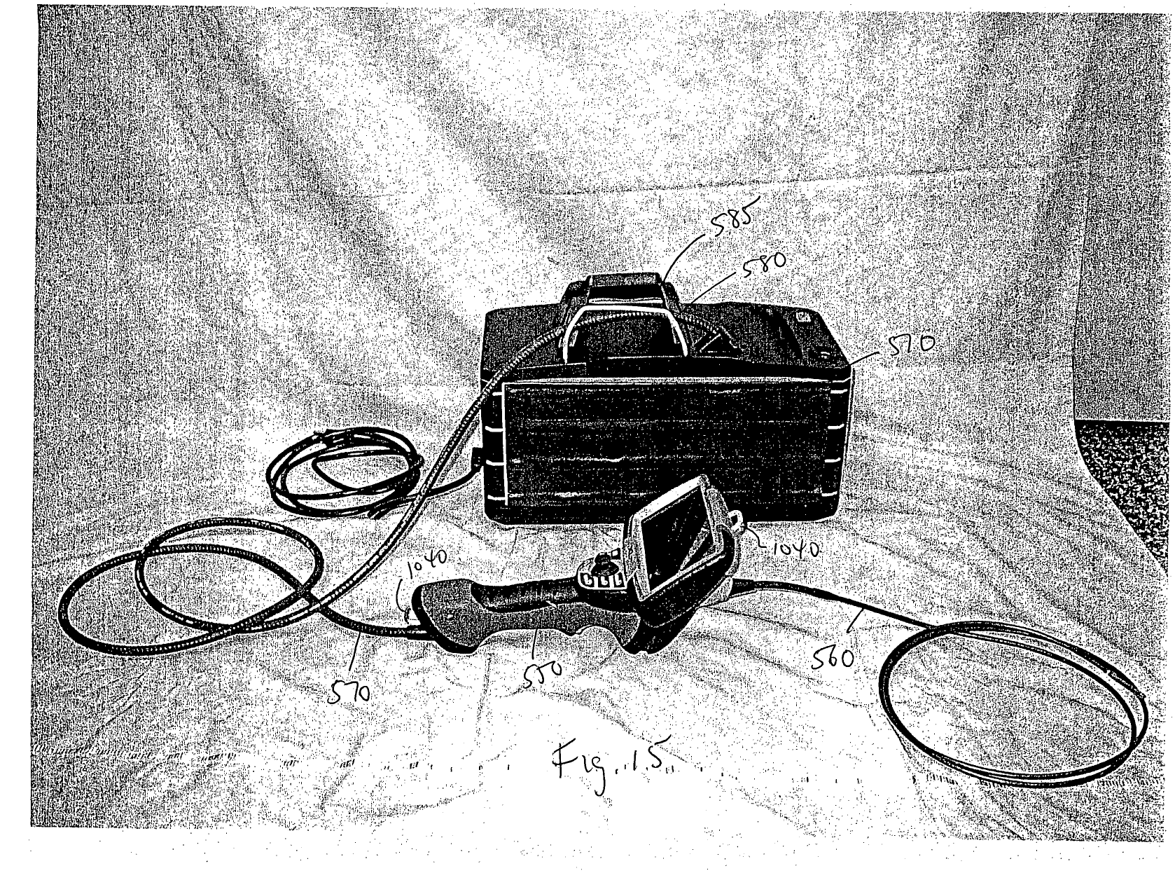

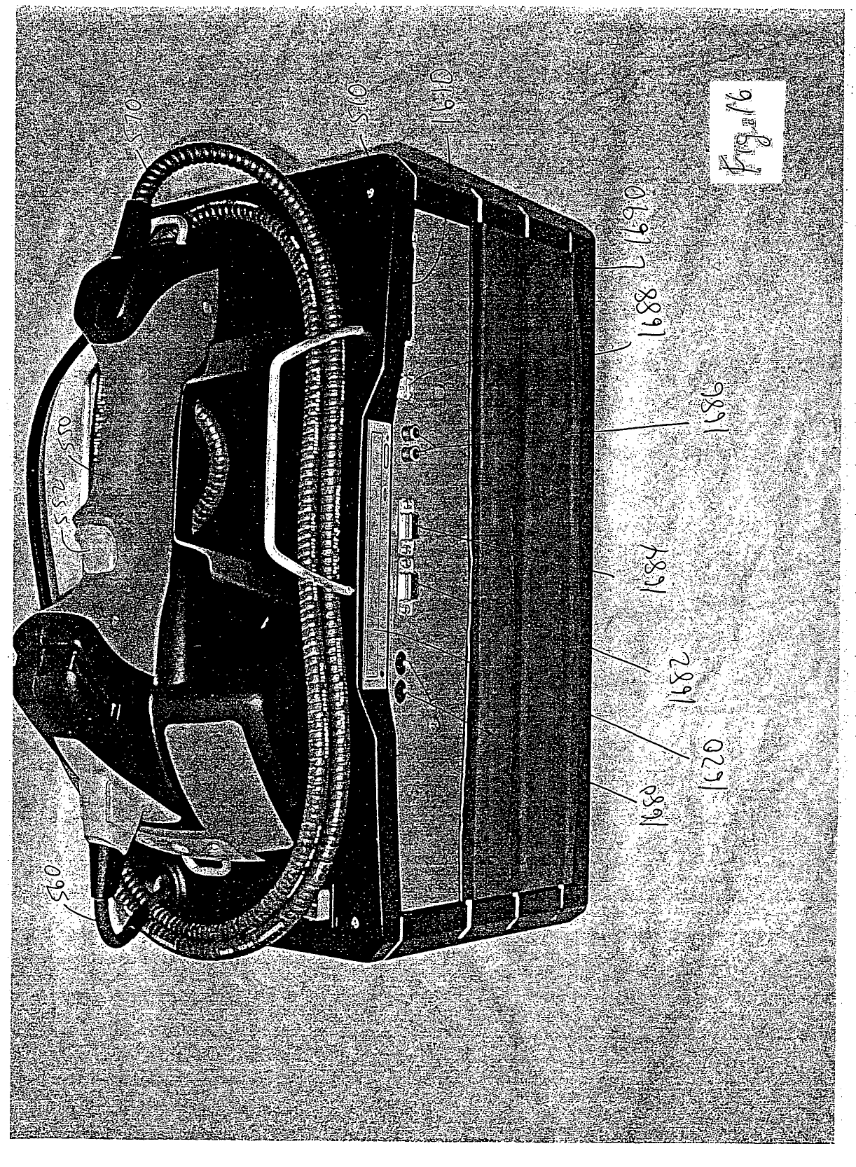

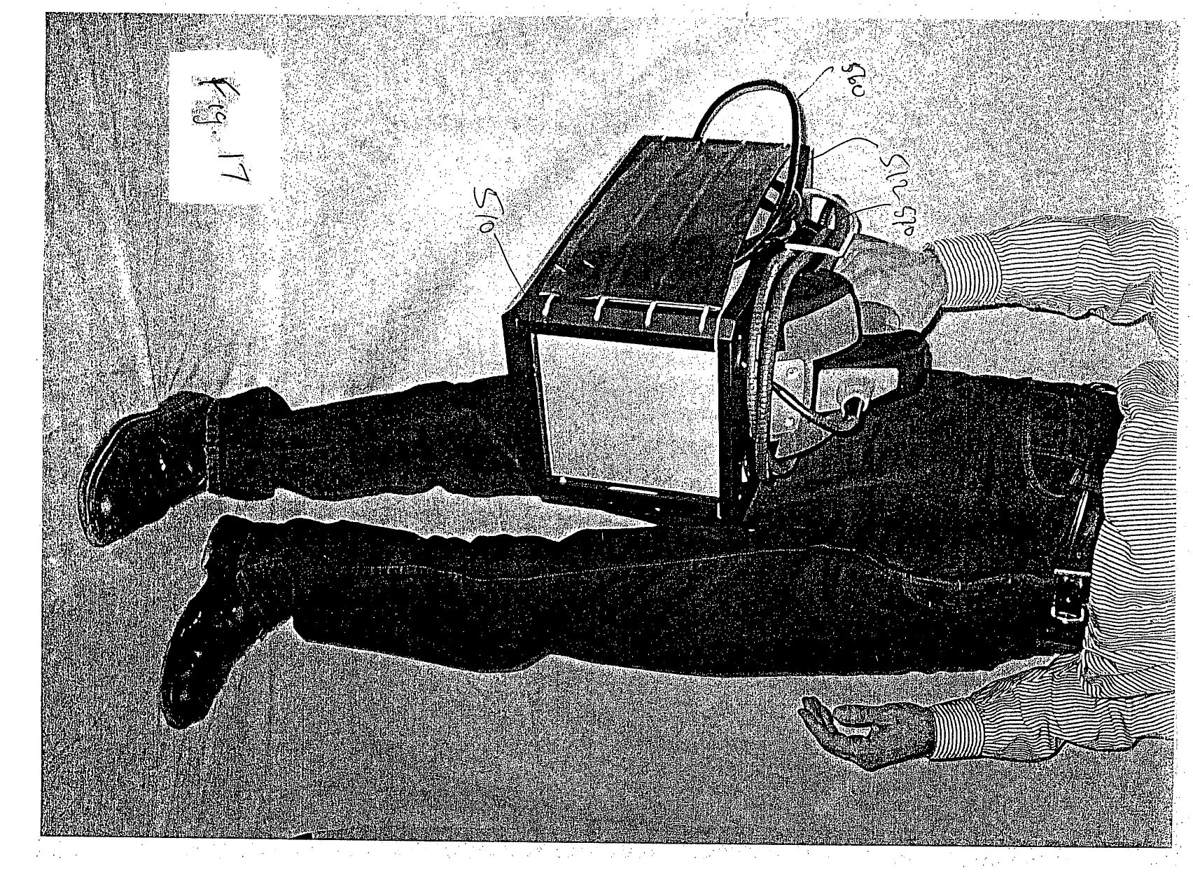

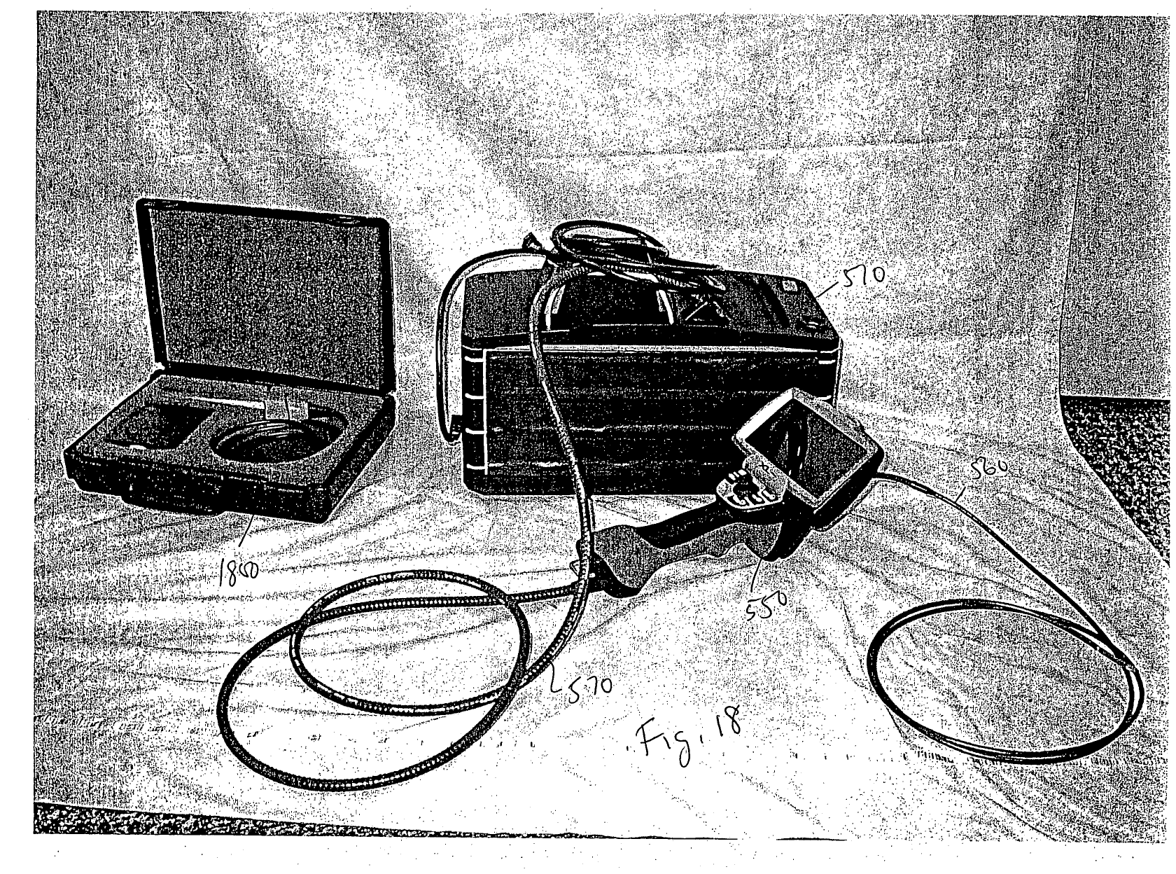

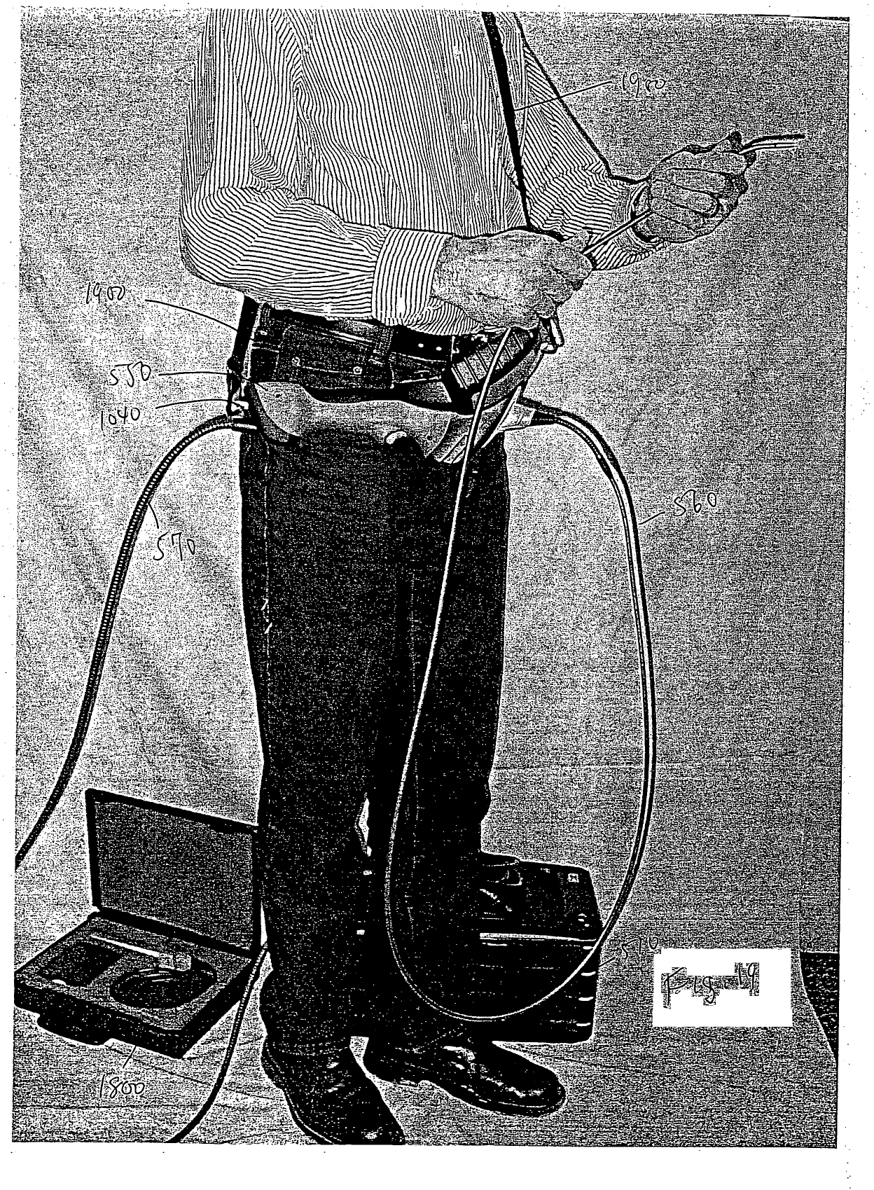

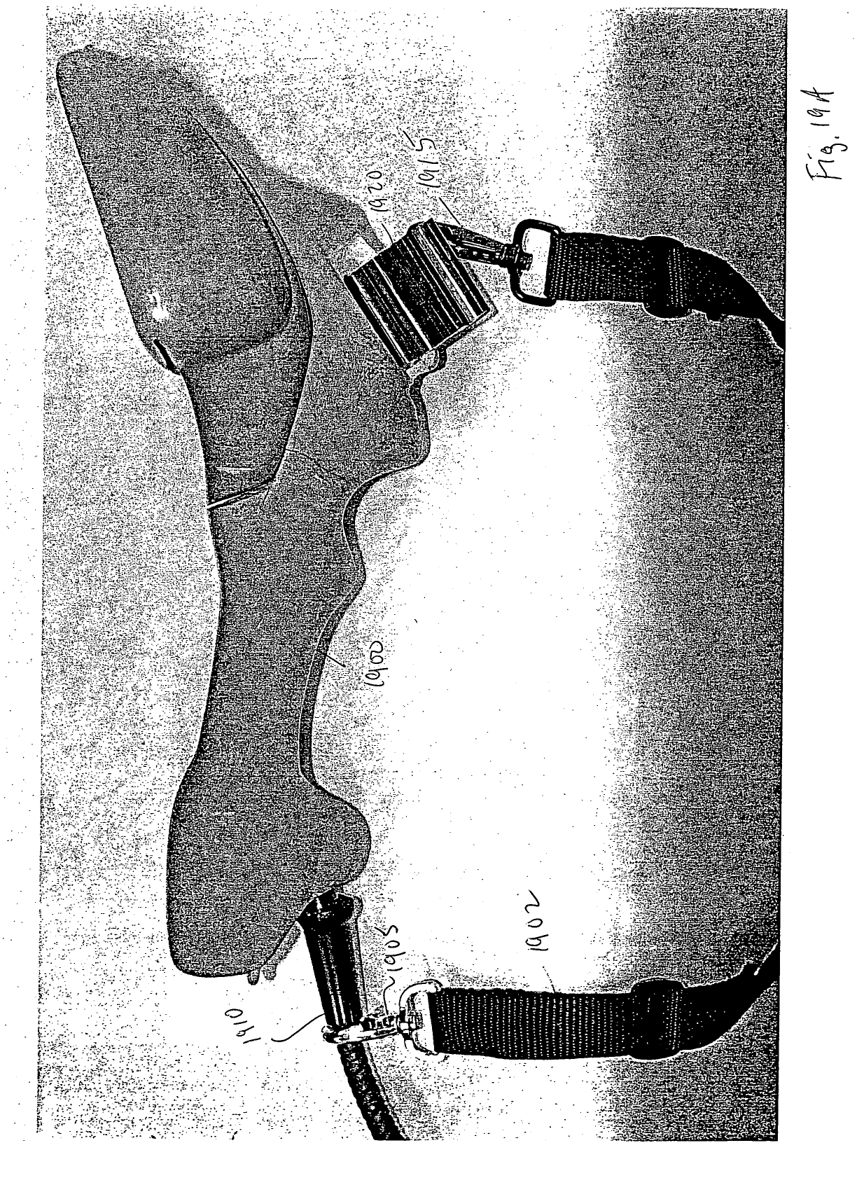

FIG. 14 illustrates features of a second embodiment, showing a close-up side view of a handset supported on a support bracket. In FIG. 14, the support bracket 595 described previously is extended, and the handset 550 comprises a mating hanging device 1400 that is designed to mate in registry with the support bracket 595 so as to support the handset 550 in a convenient orientation.

FIG. 15 illustrates features of a second embodiment, showing a base module 510 with a handset 550, cable 570 and insertion tube 560 in deployed configuration. Also readily visible in FIG. 15 are both handles 580 that can be used to carry the base module when the handset 550, cable 570 and insertion tube 560 are stowed.

FIG. 16 illustrates features of a second embodiment, showing a base module 510 with a handset 550, cable 570 and insertion tube 560 in stowed configuration. FIG. 16 also illustrates the following elements of the remote video inspection system 100 that have been described hereinabove: trigger 552 on an underside of handset 550; an aperture 1610 that in some embodiments accepts PCMCIA cards or PC cards, which can for example implement functionality comprising modems, Ethernet, and Firewire®, as well as electronic storage media, such as Compact Flash cards, PCMCIA cards having memory, PC cards, or alternatively SD or SDIO memory; and an opening 1620 is the opening of a DVD drive or a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks). FIG. 16 also depicts structures 1680 (S-video in/out connectors), 1682 (VGA out connector), 1684 (DVI out connector), 1686 (Audio in/out connectors), and 1688 (USB port).

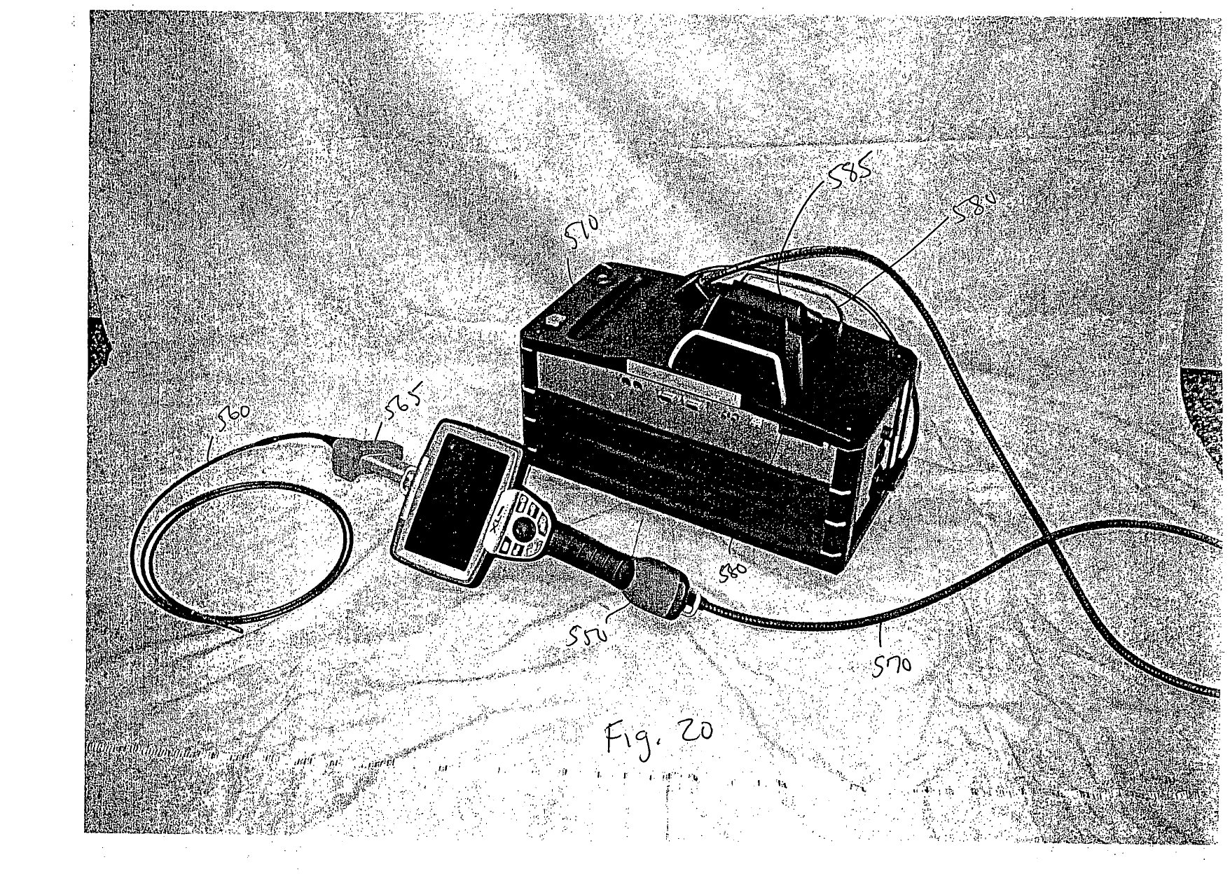

FIG. 17 illustrates features of a second embodiment, showing a base module 510 with a handset 550, cable 570 and insertion tube 560 in stowed configuration being transported in one hand of a user. In FIG. 17, the user is carrying the base module and the associated components by holding the assemblage by the handset 550 itself, which handset 550 is supported on the base module 510 with a support (as is more clearly seen in FIG. 20). FIG. 17 also shows a pocket 512 on one side of the base module 510, which pocket 512 contains and supports a portion of insertion tube 560. In an alternative embodiment, the user can carry a base module 510 with a handset 550, cable 570 and insertion tube 560 in stowed configuration by holding the handles 580. This portable package also includes the battery which is detachably mounted to the base module 510, for example at the bottom thereof.

FIG. 18 illustrates features of a second embodiment, showing a base module 510 with a handset 550, cable 570 and insertion tube 560 in deployed configuration, with a spare insertion tube in an opened storage container 1800.

FIG. 19 illustrates features of a second embodiment, showing a base module 510 with a handset 550, cable 570 and insertion tube 560 in deployed configuration. In FIG. 19, a shoulder strap 1900 is attached to the rings 1040 of the handset 550. The handset 550 is shown slung from the shoulder strap 1900 that is being worn over the shoulder of a user, who has both hands free to manipulate the insertion tube 560.

FIG. 19A is a drawing showing an alternative strap 1902 embodiment in which there are no hooks on the handset 1900. One end of the strap 1905 attaches to the power tube strain relief 1910 and another end of the strap 1915 attaches to a mounting bracket feature 1920 which is used to allow attachment to the handle of the case and to a “magic arm.”

FIG. 20 illustrates features of a second embodiment, showing a base module 510 with a handset 550, cable 570 and insertion tube 560 in deployed configuration. At the proximal end of the insertion tube 560 there is a pod assembly 565 that comprises a quick disconnect/strain relief structure 565 and other components that are described more fully hereinbelow with respect to FIG. 22. In FIG. 20, there is also a handle 585 that is designed to support and conform to the handset 550 when stowed, and which further provides a hand grip for carrying the assembly when in stowed configuration. The handle 585 is centrally situated between the two handles 580 that serve to confine the stowed cable 570 and insertion tube 560.

The possibility of using interchangeable insertion tubes presents some challenges. Different insertion tubes can comprise different components, such as different CCD imager types, different harnesses connecting to the CCD imagers, and different electronic circuits adjacent to the CCD imagers in the distal end of the insertion tube. They also can comprise illumination bundles with different light-transmission characteristics. Many insertion tubes also comprise associated detachable optical measurement tip adapters that preferably are calibrated with the individual insertion tube to achieve more accurate measurement results. In some embodiments, insertion tubes of different diameters use articulation cables with varying mechanical properties such as stretch or break strength. The insertion tubes can comprise articulation actuators with varying properties or parameters such as leadscrew pitch or length. These differences are accommodated in various embodiments. The main imager DSP and associated electronics are contained in display module 130/manually operated control module 250. Additional circuitry may be included in pod 262 to perform such functions as outgoing CCD clock waveshaping and amplification of the returning analog video signal with a tailored frequency response to best match the specific imager and harness in that particular insertion tube. In some embodiments, a non-volatile memory is included in the pod for storage of parameters related to the signal processing required to produce an image with proper color balance, sharpness, etc. from the particular insertion tube being used. This memory also contains measurement calibration data sets for each of the optical measurement tip adapters that have been calibrated with the insertion tube. This memory also contains parameters related to articulation such as maximum travel limits, torque limits, articulation rates, calibrated articulation center position and the like. Various metrics such as a history of thermal excursions on the distal tip (for probes that have thermal sensors in the distal end of the probe), number of articulation cycles, total on-time, etc. may also be stored in this memory. Various other data such as the insertion tube serial number, service history, build date, build configuration, diameter, length, feature set keys, thermal warning limits, thermal sensor parameters, CCD voltage requirements and the like may also be stored in this memory. The data in the memory is accessed by a microcontroller in display module 130/manually operated control module 250 and loaded into the CCD DSP, sent over the serial link to base module 110, or used locally as appropriate. Data can be written to the memory by the microcontroller in a similar manner.

FIG. 21 illustrates features of a second embodiment, showing a handset 550, cable 570 and insertion tube 560 in deployed configuration. As in FIG. 19, a user wears a shoulder strap 1900 that supports the handset 550 when the user is not holding it. In FIG. 21, the user is in fact holding the handset 550 by one hand, and is holding the disconnected insertion tube 560 in his other hand. In FIG. 21, there are shown three circular LEDs 2105, 2110, 2115 at the top of the handset near where the strap attaches to the hook. The LEDs 2105, 2110, 2115 provide a flashlight-type function for the user to be able to have some illumination at the worksite. An example where this would be require would be during a night time flight line inspection where the operator is trying to read inspection “paperwork” in the dark. In FIG. 21, the pod structure 565 is shown in disconnected configuration from the handset 550.

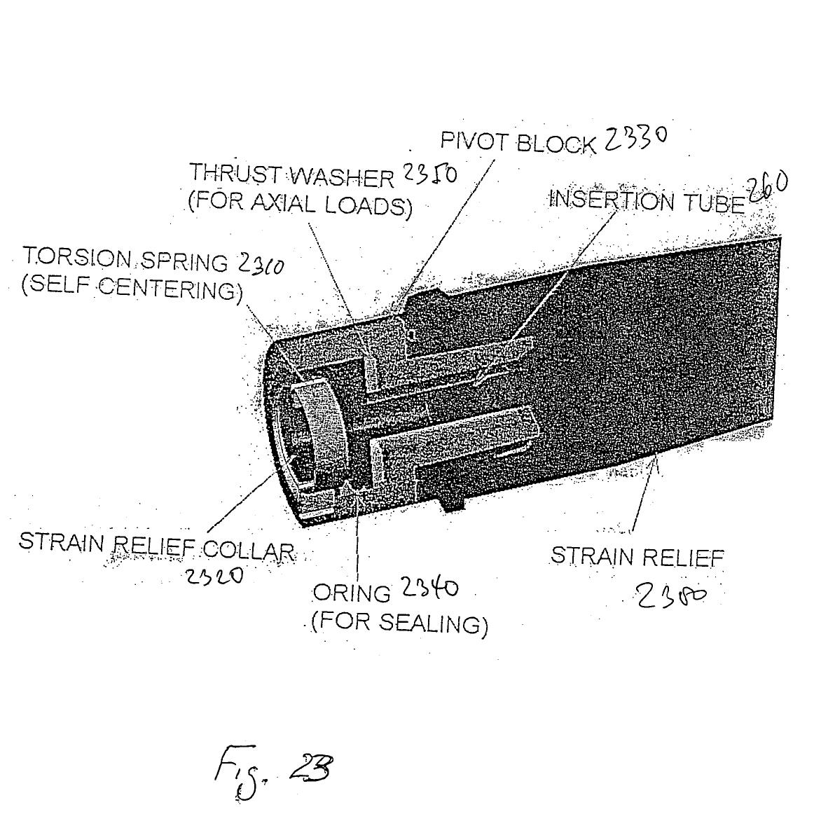

FIG. 22 illustrates features of a second embodiment, showing a cross-sectional drawing of the handset 550. In FIG. 22, the handset 550 comprises the display module 130, the joystick 252, and the trigger 2200. At the left side of FIG. 22, there is shown a pod assembly 2220 that comprises a strain relief 2220 described in greater detail with respect to FIG. 23 hereinbelow. The pod assembly 2220 mates with the handset 550. An electrical connector 2230 is provided in the pod to connect the electrical conductors that are needed to convey the electrical signals described above between the handset and the insertion tube 560. A mating connector is provided in the handset. The pod assembly 2220 comprises a lead screw assembly 2240 that provides a calibration and adjustment feature with regard to the tungsten articulation cables that are used for guiding a distal tip of the insertion tube 560. The calibration and adjustment feature uses a procedure wherein the amount of rotation that a motor 2250 must turn in order to displace a tip of an insertion tube by a known amount is periodically recorded. As the articulation cable or other components of the system stretch or otherwise deform, the system recognizes that a change in the amount that the motor 2240 must turn has occurred. The system responds by driving the lead screw mechanism so as to compensate for the change in motion that the motor must perform, thereby causing the desired displacement to occur at some other different motor rotation as was the situation originally.

In another embodiment for making corrections, the distortion noted over time is used to construct a correction function or correction table in a memory. When a desired angular displacement is requested by a user, the system compensates for the distortions by operating the motor 2240 at a proportionally changed rate, so as to maintain an actual response that conforms to the expected response on the part of the user.

The handset also comprises a motor drive connector 2260 that connects the motors 2250 with the articulation cables, as explained hereinabove with regard to FIG. 3. The handset comprises a fiber optic connector 2270 comprising spring loaded concentric polished optical end ferrules for connecting the respective optical fibers within the insertion tube 260 with the optical system of the handset 550 and the optical source provided in the base module 510.

FIG. 23 illustrates features of an embodiment, showing in cross-section a strain relief that is partially depicted in FIG. 22. The insertion tube can include a strain relief/torsion assembly at the handset end thereof. This strain relief/torsion assembly includes a torsion spring that is fitted into the front of a strain relief collar as fitted into a pivot block attached to the proximal end of the insertion tube. The strain relief collar is provided with an O-ring to create a fluid-tight seal and to provide a drag force on the insertion tube assembly. The collar enables the assembly to rotate about the mounting axis and provides a limit to rotation to ensure that the fiber bundle the cables/imager harnesses contained within the assembly are not twisted beyond 180 degrees.

As shown in FIG. 23, a pivot block provides an anchor for an insertion tube pod assembly that mates to the handset. Preferably, the pivot block is the stationary component of the design and is fastened to the pod by means of a threaded fastener (not shown), thereby effectively creating strain relief by transferring the strain onto the outer portion of the pod and therethrough to the handset. A slip coupling provides torsion relief at the point where the insertion tube 260 exits from the handset. The coupling also allows the insertion tube to rotate relative to the handset through an angular displacement which can range from 270 degrees to substantially 360 degrees. In some embodiments, a Teflon™ or other suitable thrust washer is also provided to insure axial (e.g., linear) loads imparted to the system will not bind the assembly in use. In some embodiments, the insertion tube includes markings indicating a length and an up direction (or a defined radial direction).

FIG. 24 illustrates a user performing an aircraft engine inspection in the field with a system in a backpack configuration.

FIG. 25 illustrates an example of a prior art inspection system that is inconvenient to carry.

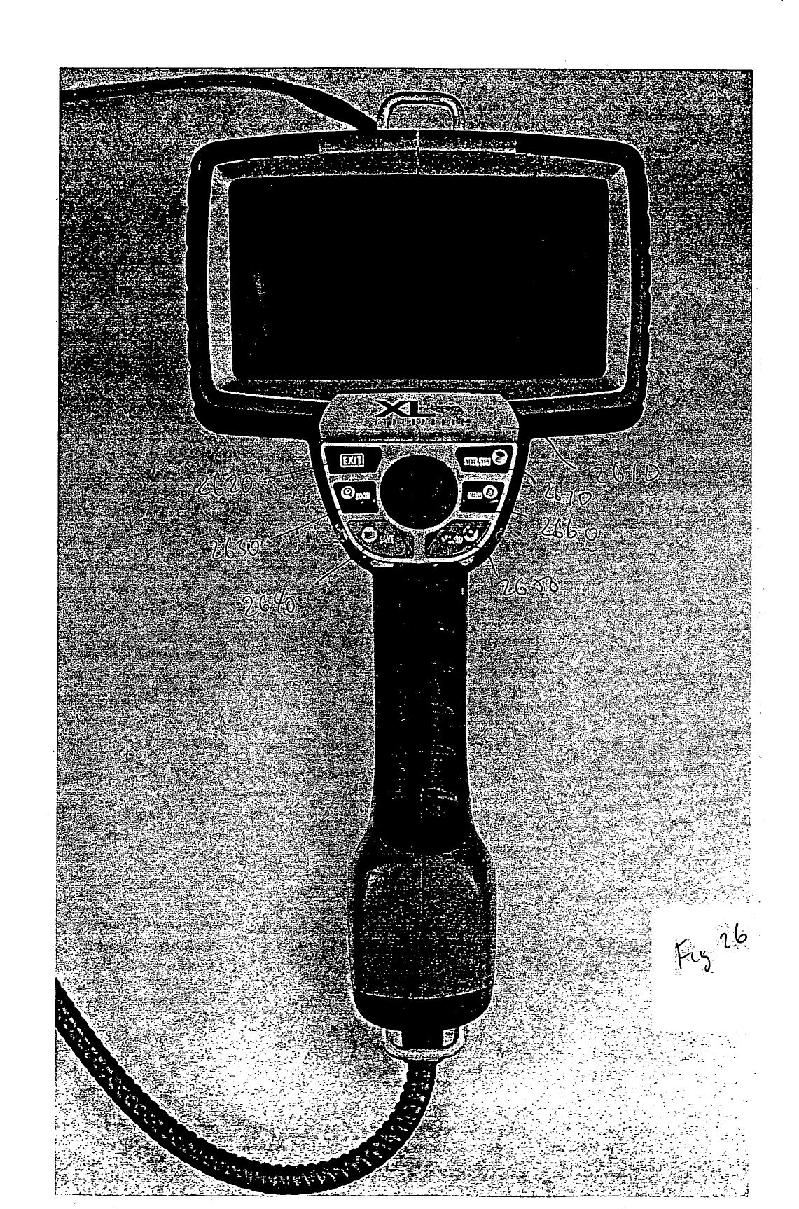

FIG. 26 is a perspective drawing that illustrates features of a handset according to principles of the invention. A drawing of the front face of the handset, including an embodiment of a user control interface 2610, is shown. Various buttons are provided for the user to depress in order to issue commands, such as the button 2620 marked “Exit” that causes a then-active program to exit when the button 2620 is depressed. Other buttons are marked, and perform preprogrammed functions as follows: the button 2630 marked “Zoom” permits the operator to zoom in (or with the use of a toggle switch, to zoom out) on an image of interest; the button 2640 marked “Save” permits the operator to save the current image; the button 2650 marked “Record” permits the user to record video; the button 2660 marked “Menu” upon activation by a user displays a menu, and when activated a second time, turns off the display of the menu; and the button 2670 marked “Steer/Stay” is the button that toggles the operation of the “steer and stay” mode of operation of the joystick 252.

FIG. 27 is a side view drawing that illustrates features of a handset according to principles of the invention. The handset comprises a trigger button 2710 on a bottom surface of the handset in a position where a digit of the user can easily activate the trigger button 2710. A Joystick 252 is visible under the thumb of the user.

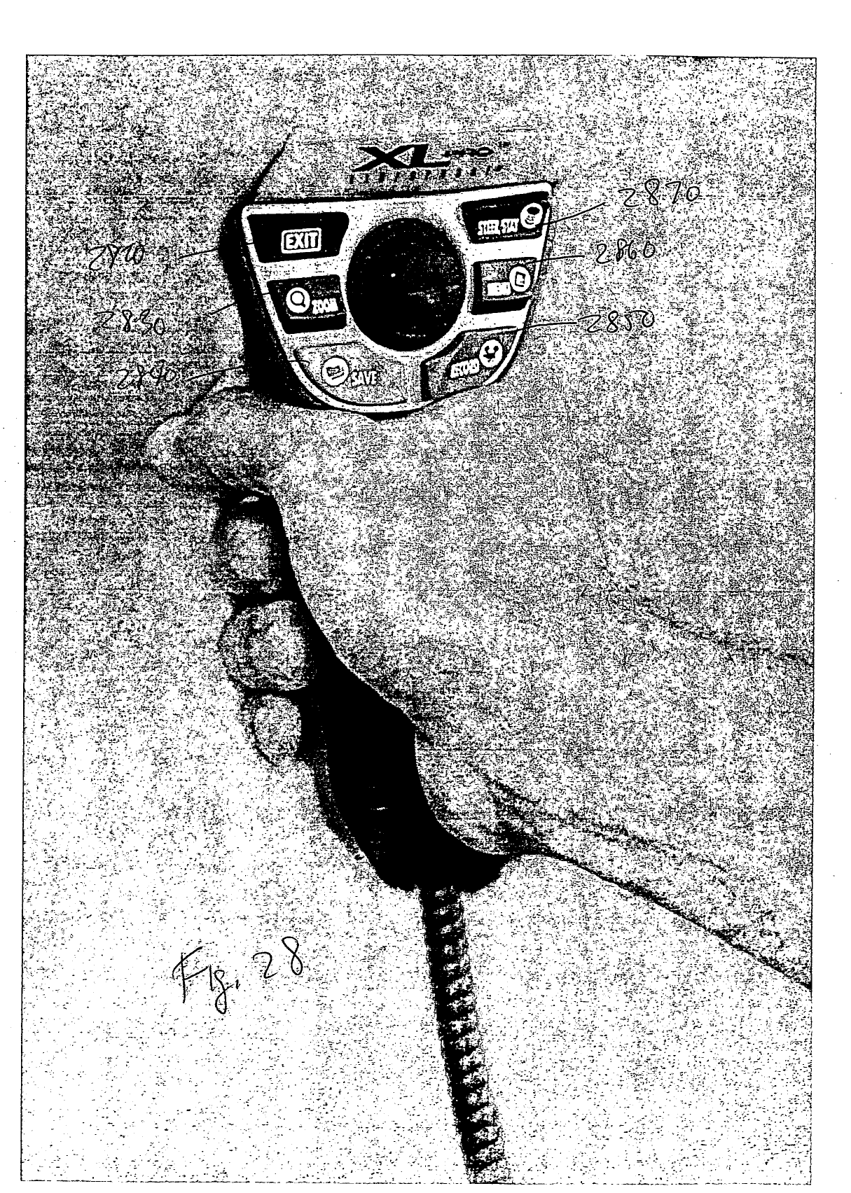

FIG. 28 is a perspective drawing that illustrates features of an accessory remote control 2800. The accessory remote control 2800 does not comprise an LCD. The accessory remote control has a joystick 252 which performs functions identical to those performed by the joystick of a handset. In one embodiment this remote control 2800 is used with an external monitor as the user interface. Various buttons are provided for the user to depress in order to issue commands, such as the button 2820 marked “Exit” that causes a then-active program to exit when the button 2820 is depressed. Other buttons are marked, and perform preprogrammed functions as follows: the button 2830 marked “Zoom” permits the operator to zoom in (or with the use of a toggle switch, to zoom out) on an image of interest; the button 2840 marked “Save” permits the operator to save the current image; the button 2850 marked “Record” permits the user to record video; the button 2860 marked “Menu” upon activation by a user displays a menu, and when activated a second time, turns off the display of the menu; and the button 2870 marked “Steer/Stay” is the button that toggles the operation of the “steer and stay” mode of operation of the joystick 252.

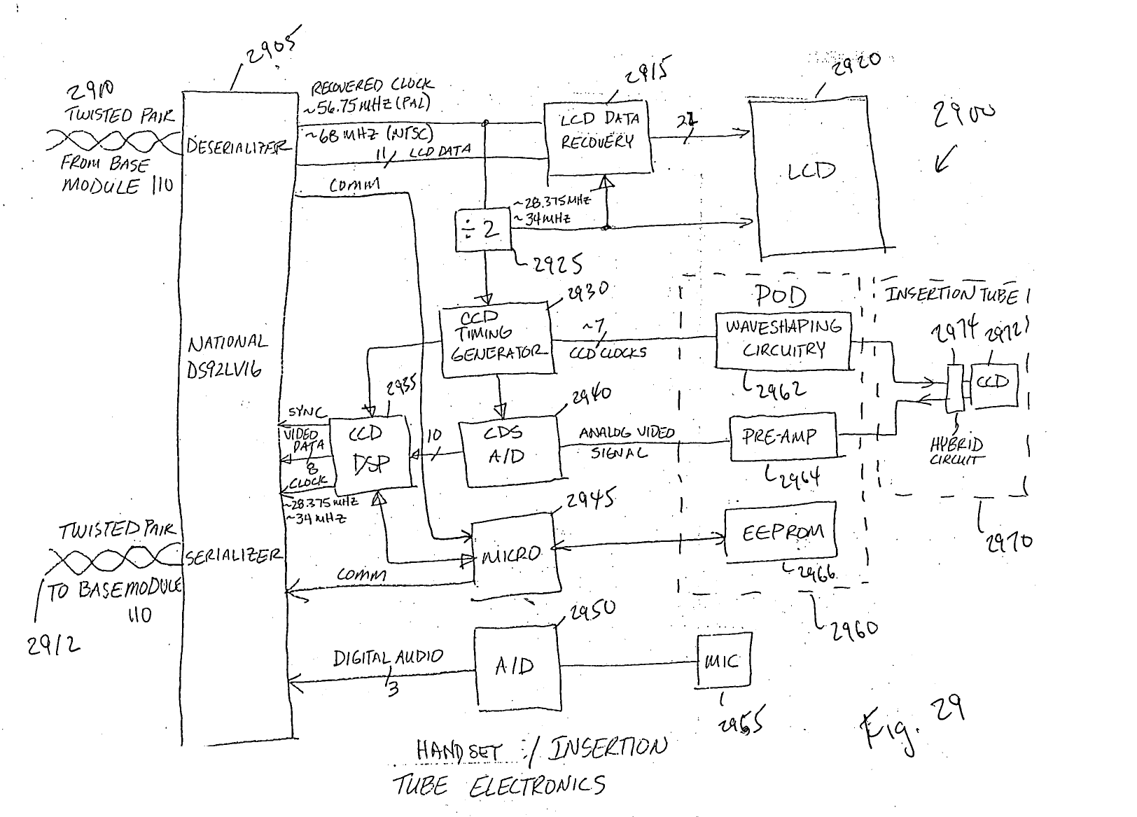

FIG. 29 is a high level block diagram of a circuit 2900 used for interfacing an insertion tube 2970 with a handset. In one embodiment, the insertion tube 2970 comprises an imager, such as CCD sensor 2972, that converts received light into electrical signals representing an image, and a hybrid circuit 2974 that manipulates the electrical signals. In one embodiment, the hybrid circuit 2974 includes a mixed mode ASIC that provides these functions. In another embodiment, the mixed mode hybrid comprises the video buffer, and one or more filters, and creates the imager drive signals from a single master clock signal into a digital timing circuit on the ASIC. The output of this timing circuit is level shifted as necessary to meet the input levels required by the imager. The insertion tube 2970 is connected to a pod 2960 that interfaces to the handset, as described hereinabove. The pod 2960 in one embodiment comprises waveshaping circuitry 2962, a pre-amplifier 2964, and an EEPROM 2966. The pre-amplifier 2964 amplifies the signals provided by the CCD sensor 2972 as manipulated by the hybrid circuit 2974. The waveshaping circuitry 2962 is active to control the behavior of the CCD sensor 2972 as a function of time. The EEPROM 2966 is a memory that contains information relating to the type of insertion tube 2970, and in some instances, to a particular insertion tube 2970, the information useful for optimizing the behavior of the insertion tube 2970.

As previously described, the pod 2960 is in electrical communication with the handset. The EEPROM 2966 is in bi-directional digital communication with a microprocessor 2945 that controls data acquisition from the insertion tube 2970 and processing of the acquired data. The pre-amplifier 2964 is in electrical communication with an analog-to-digital converter (A/D) 2940. An analog video signal provided by the pre-amplifier is digitized by the A/D 2940. The output of the A/D is a parallel output, shown in the embodiment as a 10-bit wide output. A hash mark crossing a connector with a numerical value thereabove is intended to indicate the number of parallel lines that the connection represents. In this regard, a connection from the A/D 2940 to the CCD digital signal processor (DSP) 2935 has a hash mark thereon and the numerical value 10 thereabove. The waveshaping circuitry 2962 receives a 7-bit signal representing 7 different clocks needed to drive a CCD imager of the type used, (e.g., 4 vertical, 2 horizontal, and 1 reset gate clocks) from the CCD timing generator 2930. The CCD timing generator 2930 also provides a timing signal for the CCD DSP 2935 and for the A/D 2940, thereby synchronizing the A/D 2940 and the CCD DSP 2935. The microprocessor 2945 is bi-directionally connected to the CCD DSP 2935 to permit the adjustment of various processing parameters of the CCD DSP 2935 as needed when an insertion tube 2970 is replaced or changed, and to permit the CCD DSP 2935 to send data to the microprocessor 2945.

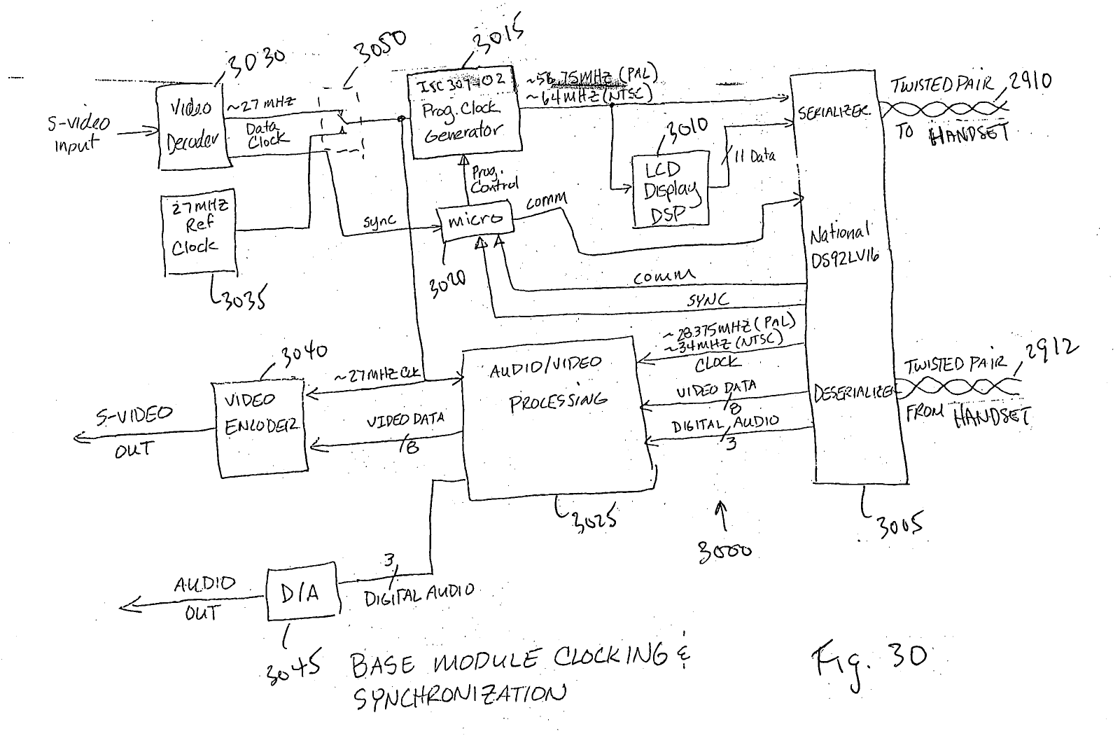

A National Semiconductor DS92LV16 serializer/deserializer 2905 is used to transmit information from the handset to the base module by way of the cable, and is also used to receive information sent from the base module to the handset by way of the cable. As described hereinabove, there are advantages to limiting the number of conductors required to communicate between the handset and the base module. In the present embodiment, a twisted pair of conductors 2910 carries serialized digital signals from the base module to the handset, and a twisted pair of conductors 2912 carries serialized digital signals from the handset to the base module. In one embodiment, the serializer/deserializer 2905 receives the following digital signals from the handset components and converts the signals into a serial stream of bits: one bit of synchronization signal from the CCD DSP 2935; 8 bits of video data from the CCD DSP 2935; one bit of clock signal from the CCD DSP 2935; optionally, 3 bits of audio data from the combination of a microphone 2955 which generates an audio analog signal that is then digitized in an A/D 2950; and command signals from the microprocessor 2945. In this embodiment, the deserializer portion of the serializer/deserializer 2905 receives a digital stream from the base module, and separates and formats the information contained in the digital stream into the following signals: a one-bit video clock signal at a selected one of approximately 56.75 MHz for PAL video formatting or approximately 68 MHz for NTSC video formatting; 11 bits of LCD data for operating an LCD display; and command signals for use by the microprocessor 2945. As will be explained with regard to FIG. 30, the video clock signal is generated at the base module. The video clock signal is provided to each of a LCD data recovery device 2915 and to a divide-by-2 module 2925. The output of the divide-by-2 is provide to all of the LCD data recovery device 2915, the LCD 2920, and the CCD timing generator 2930. The LCD data is provided to the LCD data recovery device 2915. The LCD data recovery device 2915 produces a 22-bit signal, comprising a one-bit timing signal, a one-bit horizontal synch signal and a one-bit vertical synch signal, and an 18-bit video signal for display by the LCD display 2920.

FIG. 30 is a high level block diagram of a circuit 3000 used for interfacing a base module with a handset. A second National Semiconductor DS92LV16 serializer/deserializer 3005 is used to transmit information from the base module to the handset by way of the cable, and is also used to receive information sent by the handset to the base module by way of the cable. As described hereinabove, there are advantages to limiting the number of conductors required to communicate between the handset and the base module. In the present embodiment, a twisted pair of conductors 2910 carries serialized digital signals from the base module to the handset, and a twisted pair of conductors 2912 carries serialized digital signals from the handset to the base module. In one embodiment, the serializer/deserializer 3005 receives the following digital signals from the base module components and converts the signals into a serial stream of bits: a one-bit video clock signal at a selected one of approximately 56.75 MHz for PAL video formatting or approximately 68 MHz for NTSC video formatting from a programmable clock generator 3015, for example the ISC307-02, a copy of which signal is also provided to the LCD display DSP 3010; 11 bits of LCD data for operating an LCD display from the LCD display DSP 3010; and command signals from microprocessor 23020. In this embodiment, the deserializer portion of the serializer/deserializer 3005 receives a digital stream from the handset, and separates and formats the information contained in the digital stream into the following signals: one bit of synchronization signal for use by the microprocessor 3020; 8 bits of video data for use by the audio/video processor 3025; one bit of clock signal for use by the audio/video processor 3025; optionally, 3 bits of audio data for use by the audio/video processor 3025; and command signals for the microprocessor 3020. The microprocessor 3020 provides command signals for program control to the programmable clock generator 3015.

There are also input and output signals associated with the base module. The audio/video processor 3025 provides 3 bits of digital audio signals to the digital-to-analog converter (D/A) 3045 which generates analog audio, that is provided to an audio output terminal. The audio/video processor 3025 provides 8 bits of digital video signals to a video encoder 3040. A clock signal having approximately 27 MHz frequency is provided to the video encoder 3040, which provides an output signal in the s-video format. The approximately 27 MHz frequency clock signal is also provided to the programmable clock generator 3015, which uses the signal to generate the PAL and/or NTSC video clocks, and to the audio/video processor 3025. The approximately 27 MHz clock signal is provided by one of a video decoder 3030 that accepts an s-video input, or by a 27 MHz reference clock. A switch 3050 is used to connect one, and only one, of the two 27 MHz signal sources to the programmable clock generator 3015, the video encoder 3040, and the audio/video processor 3025. When the s-video input 3030 is active, a synch signal is provided from the input 3030 to the microprocessor 3020.

Additional System Capabilities

The system according to the invention comprises a diagnostic capability or self-test capability to troubleshoot which modules or components of the system need to be repaired or replaced, including a diagnostic module to perform the testing. The diagnostic module in some embodiments is a software module that performs tests under the supervision of a user, or that performs tests at predefined times, such as system start-up, or at a time when the system is idle after the system has operated for at least a defined time period (e.g., a specified number of hours).

In some embodiments, the inspection system according to the invention comprises a system with stereo audio output. In some embodiments, the inspection system according to the invention comprises a system with a game mode, in which the system can be used to play video games.

The system can add, change or modify the behavior of software modules (e.g., programs, data stashes, drives, interface modules such as .dll or .ocx files) and can adjust or control hardware functions by changing software commands or data or by reprogramming one or more computers. The system can use any of the components thereof, including but not limited to a PC Card, a device situated in a device bay, external interfaces such as Firewire® or USB, a PCI slot or other similar expansion capabilities of a PC to add any of the following hardware or software functions or capabilities to the system: expanded or reconfigured memory; acceleration hardware and/or software to improve process speed or add expansion capabilities; a modem; a printer; an IRDA interface; a hard drive; a network connection, such as a LAN or WAN; a docking station to factory or end users network; the use of voice over internet protocol (VoIP); connections to or by way of cellular telephone or land line; hardware devices such as an eddy current probe, or an ultrasonic probe; an engine turning tool or electronic turnover tool (e.g., a device used to rotate the rotors of turbine engines in steps to allow the easy inspection and counting of each blade); the ability to play video games or to play music, such as MP3 files; the provision of user maintenance manuals; the provision of a user report generation capability; the provision of automatic fault detection, which detection can interface with a database of users manual, and or one or more pass/fail criteria; a programming capability such as a macro function that allows users to set up repeating operations, for example controlled articulation that allows viewing an object, such as a blade of a jet engine, that is larger than a field of view; the provision of user configurable system, such as menus, and the provision of diagnostic features and functions that a user can download as needed. It is contemplated that these functions can be added at the time of manufacture (as an option) or by the user in the field at a later time.

Those of ordinary skill will recognize that many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein.

While the present invention has been explained with reference to the structure disclosed herein, it is not confined to the details set forth and this invention is intended to cover any modifications and changes as may come within the scope and spirit of the following claims.

1. A modular remote visual inspection system used to view a portion of an interior of an object of interest, comprising:
a base module comprising an optical source module, a computation module, and a power module;
an interconnection module having two ends, said interconnection module providing electrical and optical signal paths, a first end of said interconnection module in electrical and optical communication with said base module;
a unitary display and control module, said unitary display and control module in electrical and optical communication with a second end of said interconnection module; and
a demountable inspection module having two ends, a proximal end of said inspection module in at least optical communication with said unitary display and control module, and a distal end of said inspection module configured to make observations of an object of interest;
whereby said base module, said interconnection module, said unitary display and control module, and said demountable inspection module cooperate to permit a view of the portion of the interior of the object of interest.

2. The modular remote visual inspection system of claim 1, wherein said base module, said interconnection module, said unitary display module and control module and said demountable inspection module are configured to be stowed in an interconnected relationship.

3. The modular remote visual inspection system of claim 2, wherein said base module, said interconnection module, said unitary display module and control module and said demountable inspection module are configured to be deployed for use without alteration of the interconnected relationship that existed when stowed.

4. The modular remote visual inspection system of claim 1, wherein said base module, said interconnection module, said unitary display module and control module and said demountable inspection module are configured to be transported in one hand of a user.

5. The modular remote visual inspection system of claim 1, wherein said base module, said interconnection module, said unitary display and control module, and said demountable inspection module are configured to be transported in one hand of a user.

6. The modular remote visual inspection system of claim 1, wherein said base module has defined on a side thereof at least one aperture for use with storage media.

7. The modular remote visual inspection system of claim 6, wherein the at least one aperture is configured to accept a storage medium selected from the group consisting of optical storage media, magnetic storage media, and electronic storage media.

8. The modular remote visual inspection system of claim 7, wherein the optical storage media comprise a selected one of a CD-R, a CD-RW, and a DVD.

9. The modular remote visual inspection system of claim 7, wherein the electronic storage media comprise a selected one of a PC card, a PCMCIA card, a Compact Flash card, an SD memory, and an SDIO memory.

10. A modular visual inspection system for viewing the interior of a structure, comprising:
a base unit element comprising a memory element, a processor element, and a light source;
a control and display element comprising a screen element for viewing the interior of the structure and an articulation control element;
a plurality of insertion elements for imaging the interior of the structure, each of said plurality of said insertion elements comprising an imaging sensor and an elongated braided portion,
wherein the base unit element is in electro-optical communication with the control and display element, and
wherein each one of said plurality of insertion elements can be used without modification with said control and display element.

11. The modular visual inspection system of claim 10, wherein the base unit element further comprises a fluid reservoir.

12. The modular visual inspection system of claim 10, wherein the base unit element further comprises a keyboard.

13. The modular visual inspection system of claim 10, wherein the base unit element has defined on a side thereof at least one aperture for use with storage media.

14. The modular visual inspection system of claim 13, wherein the at least one aperture is sized to allow insertion of a storage media selected from the group consisting of: optical storage media, magnetic storage media, and electronic storage media.

15. The modular visual inspection system of claim 14, wherein the optical storage media comprise CD-Rs, CD-RWs, and DVDs.

16. The modular visual inspection system of claim of claim 14, wherein the magnetic storage media comprise floppy disks and magnetic tape.

17. The modular visual inspection system of claim 14, wherein the electronic storage media comprise PC cards, PCMCIA cards, Compact Flash cards, SD memory, and SDIO memory.

18. The modular visual inspection system of claim 10, wherein the processor element of the base unit element is capable of video compression.

19. The modular visual inspection system of claim 10, wherein the base unit further comprises at least one connectivity element.

20. The modular visual inspection system of claim 19, wherein the at least one connectivity element is selected from the group of connectivity elements consisting of: serial ports, USB ports, Firewire® (IEEE 1394) ports, and infrared communication ports.

21. The modular visual inspection system of claim 10, wherein the light source is modular.

22. The modular visual inspection system of claim 21, wherein the modular light source is selected from the group of light sources consisting of: LEDs, arc discharge lamps, lasers, UV lamps, and IR lamps.

23. The modular visual inspection system of claim 10, further comprising a storage reel for storing said plurality of insertion elements.

24. The modular visual inspection system of claim 10, further comprising a container element sized such that the base unit element fits within the container element.

25. The modular visual inspection system of claim 24, wherein the container element is weatherproof.

26. The modular visual inspection system of claim 10, wherein the control and display element comprises a LCD configured to show images in a 16:9 format.

27. The modular visual inspection system of claim 10, wherein the control and display element comprises an anti-glare element.

28. The modular visual inspection system of claim 10, wherein the control and display element comprises a joystick.

29. The modular visual inspection system of claim 28, wherein the control and display element further comprises a switch to freeze an image displayed by said control and display element.

30. The modular visual inspection system of claim 10, wherein the control and display element comprises at least one servo motor.

31. The modular visual inspection system of claim 10, wherein the image sensor of each of said plurality of insertion elements gathers sufficient data to create a video signal selected from the group of video signals consisting of: PAL, NTSC, and progressive scan.

32. The modular visual inspection system of claim 31, wherein the video signal is selected by a user of the modular visual inspection system.

33. The modular visual inspection system of claim 10, wherein the memory element of the base unit element is capable of storing data representing images.

34. The modular visual inspection system of claim 10, wherein the memory element of the base unit element includes a computer program for generating reports based on data obtained by the imaging sensor of each of said plurality of insertion elements.

35. A modular visual inspection device for viewing a target area comprising:
a base unit;
a handset in electrical and optical communication with said base unit;
a plurality of interchangeable insertion tubes each having a differing cross-sectional dimension and comprising an imager for collecting data regarding the target area and at least one illumination bundle,
wherein the handset and base unit are adapted to be in electrical and optical communication with each of said plurality of interchangeable insertion tubes.

36. The modular visual inspection device of claim 35 further comprising means for distortion correcting an image generated from the data collected by the imager.

37. The modular visual inspection device of claim 35, wherein the handset further comprises at least one motor.

38. The modular inspection device of claim 35, further comprising means for connecting the modular inspection device to a computer located at a remote location.

39. The modular inspection device of claim 35, further comprising means for providing entertainment to a user of the modular inspection device.

40. The modular inspection device of claim 35, further comprising means for storing the modular inspection device.
